(19) United States
(12) Patent Application Publication
(10) Pub. No.: US 2020/0228627 A1
(43) Pub. Date: Jul. 16, 2020

(54) DISTRIBUTED DATA TRANSFER CONTROL FOR REDUCING A VOLUME OF DATA RETAINED BY A MOBILE TERMINAL

(71) Applicant: FUJITSU LIMITED, Kawasaki-shi (JP)

(72) Inventor: MIHO KAWANO, Hamamatsu (JP)

(73) Assignee: FUJITSU LIMITED, Kawasaki-shi (JP)

(21) Appl. No.: 16/720,117

(22) Filed: Dec. 19, 2019

(30) Foreign Application Priority Data
Jan. 11, 2019 (JP) 2019-003095

(51) Int. Cl. H04L 29/08; H04W 4/02

(52) U.S. Cl. CPC H04L 67/327; H04L 67/2842; H04W 88/182; H04W 4/026; H04W 4/027; H04L 67/1097

(57) ABSTRACT

An apparatus receives a data-acquisition request of data retained by servers from a mobile terminal wirelessly coupled to a base station. When a first list is not included in the data-acquisition request, the apparatus acquires, from a management server, a second list indicating the servers as a data-retention server that retains the data, where the first list indicates some of the servers as the data-retention server. Based on a communication speed between the apparatus and each data-retention server indicated in the first or second list, the apparatus identifies one data-retention server as an acquisition-destination server. The apparatus creates a third or fourth list depending on whether the mobile terminal is capable of completing acquisition of the data in a period in which the mobile terminal stays within a communication available range of the base station, and transmits the data, and the third or fourth list to the mobile terminal.

### CROSS-REFERENCE TO RELATED APPLICATION

This application is based upon and claims the benefit of priority of the prior Japanese Patent Application No. 2019-3095, filed on Jan. 11, 2019, the entire contents of which are incorporated herein by reference.

### FIELD

The embodiments discussed herein are related to distributed data transfer control for reducing a volume of data retained by a mobile terminal.

### BACKGROUND

In mobile communication, a center server is capable of transmitting data retained by the center server to a mobile terminal (user equipment: may be referred to as a UE). In a mobile communication system in which the center server transmits data retained by the server, if the size of the system increases, an access is concentrated on the center server, and thus a load on the center server becomes too much. In a large-scale mobile communication system, copy data may be retained in a plurality of edge servers (ESs). In this case, the UE acquires data from the closest ES. Thus, it is possible to increase processing efficiency by distributing data acquisition destinations and to reduce a data acquisition time by acquiring data from the close ES.

An ES that has received a data acquisition request from the UE determines the closest ES that retains data required from the UE. For example, the ES that has received the data acquisition request from the UE acquires a list (copy-data retention ES list) of servers that retain the requested data, from the center server. The ES that has received the request specifies the closest ES that retains the data, based on the acquired list. The ES that has received the request acquires data from the specified ES and transmits the data to the UE as a request transmission source.

As a technology useful for transmitting data to a UE, for example, an information processing method of speeding up the output of contents in a mobile environment is proposed. An information processing system that suppresses wasteful communication by copying cache data is proposed.

International Publication Pamphlet No. WO 2015/166680 and Japanese Laid-open Patent Publication No. 2018-77588 are examples of related art.

### SUMMARY

According to an aspect of the embodiments, an apparatus receives a data acquisition request of data retained by a plurality of servers from a mobile terminal wirelessly coupled to a base station, and determines whether a first list is included in the data acquisition request, where the first list indicates at least some of the plurality of servers as a data retention server that retains the data. When the first list is not included in the data acquisition request, the apparatus acquires a second list indicating the plurality of servers as the data retention server, from a management server that manages a distributed storage destination of the data. Based on a communication speed between the distributed data transfer control device and each of the data retention servers indicated in the first list or the second list, the apparatus identifies one of the data retention servers as an acquisition destination server to acquire the data from the acquisition destination server, and determines whether the mobile terminal is capable of completing acquisition of the data in a period in which the mobile terminal stays within a communication available range of the base station, based on a current position, a movement direction, and a movement speed of the mobile terminal and a data size of the data. The apparatus creates a third list indicating the acquisition destination server as the data retention server when it is determined that completion of acquisition of the data in the period is possible, and creates a fourth list that indicates two or more of the plurality of servers indicated in the second list as the data retention server when it is determined that the completion of the acquisition of the data in the period is not possible. The apparatus transmits the data, and the third list or the fourth list to the mobile terminal.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a system according to a first embodiment;

FIG. 2 is a diagram illustrating a first example of processing in response to a data acquisition request;

FIG. 3 is a diagram illustrating a second example of the processing in response to the data acquisition request;

FIG. 4 is a diagram illustrating an example of a system configuration according to a second embodiment;

FIG. 5 is a diagram illustrating an example of hardware of an ES;

FIG. 6 is a diagram illustrating an example of hardware of a UE;

FIG. 7 is a diagram illustrating an example of a first data acquisition process;

FIG. 8 is a diagram illustrating an example of a second and the subsequent data acquisition process;

FIG. 9 is a diagram illustrating a reason of increasing a cache size;

FIG. 10 is a diagram illustrating a determination example of reducing a size of a copy-data retention ES list;

FIG. 11 is a block diagram illustrating functions of each device;

FIG. 12 is a diagram illustrating an example of inter-ES delay information;

FIG. 13 is a diagram illustrating an example of a transfer data group;

FIG. 14 is a diagram illustrating an example of a directory;

FIG. 15 is a diagram illustrating an example of a coupling tendency log;

FIG. 16 is a diagram illustrating an example of copy data;

FIG. 17 is a diagram illustrating an example of a determination model;

FIG. 18 is a diagram illustrating an example of ES position information;

FIG. 19 is a diagram illustrating an example of adjacent ES information;

FIG. 20 is a diagram illustrating an example of a directory cache;

FIG. 21 is a diagram illustrating a generation example of the determination model;

FIG. 22 is a diagram illustrating a definition example of a boundary e;

FIG. 23 is a diagram illustrating an example of a decision tree;

FIG. 24 is a diagram illustrating an example of cache size determination;

FIG. 25 is a flowchart illustrating an example of a procedure of a copy data providing process;

FIG. 26 is a flowchart illustrating an example of a procedure of a copy data acquisition process;

FIG. 27 is a flowchart illustrating an example of a procedure of a response generation process;

FIG. 28 is a flowchart illustrating an example of a procedure of a coupling tendency log update process;

FIG. 29 is a flowchart illustrating an example of a procedure of a coupling tendency log providing process by an ES;

FIG. 30 is a flowchart illustrating an example of a procedure of a coupling tendency log acquisition process by a center server;

FIG. 31 is a flowchart illustrating an example of a procedure of a determination model creation process;

FIG. 32 is a sequence diagram illustrating a first example of an acquisition process of copy data by the UE;

FIG. 33 is a sequence diagram illustrating a second example of the acquisition process of the copy data by the UE;

FIG. 34 is a diagram illustrating an example of a communication available range of one AP;

FIG. 35 is a diagram illustrating a determination example of a size of the copy-data retention ES list retained by the UE, depending on a movement direction of the UE;

FIG. 36 is a flowchart illustrating an example of a procedure of a response generation process according to a third embodiment;

FIG. 37 is a diagram illustrating a determination example of the size of the copy-data retention ES list retained by the UE, depending on a movement distance of the UE;

FIG. 38 is a flowchart illustrating an example of a procedure of a response generation process according to a fourth embodiment;

FIG. 39 is a diagram illustrating an example of the copy data acquisition process in a case where a processing load of the ES becomes too much; and

FIG. 40 is a flowchart illustrating an example of a procedure of a copy data acquisition process according to a fifth embodiment.

### DESCRIPTION OF EMBODIMENTS

In a case where the ES acquires a copy-data retention ES list from the center server every time the data acquisition request is output from the UE, the number of inquiry of the copy-data retention ES list from the center server increases with an increase of the number of data acquisition requests. In order to reduce a communication load between the ES and the center server, it is considered that the UE retains a copy-data retention ES list for data which has been previously acquired. Thus, in a case where the UE repeats a data acquisition requests for the same data as before, it is not desirable to acquire the copy-data retention ES list from the center server by notifying the ES of the copy-data retention ES list provided in the UE, at the second time and thereafter. Further, holding a copy-data retention ES list in a UE allows the UE to utilize the copy-data retention ES list even when the UE is connected to another ES.

However, since information for specifying all ESs having copy data is included in the copy-data retention ES list, the data volume of the copy-data retention ES list increases as the size of the system becomes larger. Further, the copy-data retention ES list is provided for each piece of acquired data. Thus, the data volume of the copy-data retention ES list retained by the UE increases, and a large amount of resources is consumed in the UE to retain the copy-data retention ES list.

In one aspect, it is desirable to reduce the volume of data retained by a mobile terminal.

The present embodiments will be described below with reference to the accompanying drawings. The embodiments are able to be implemented by combining a plurality of embodiments without any contraction.

### First Embodiment

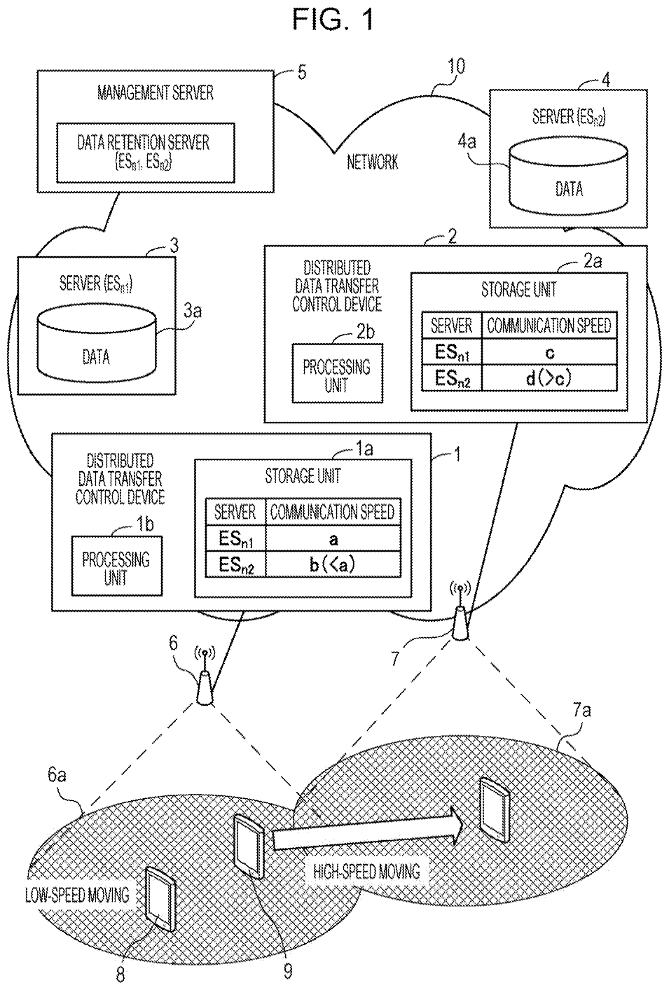

FIG. 1 is a diagram illustrating an example of a system according to a first embodiment. FIG. 1 illustrates an example of a case where a distributed data transfer control method is performed with distributed data transfer control devices 1 and 2. The distributed data transfer control devices 1 and 2 may execute, for example, a distributed data transfer control program in which a process procedure of the distributed data transfer control method is described, to perform the distributed data transfer control method.

The distributed data transfer control device 1 includes a storage unit 1a and a processing unit 1b in order to realize the distributed data transfer control method. The storage unit 1a is a memory or a storage device provided in the distributed data transfer control device 1, for example. The processing unit 1b is a processor or an arithmetic operation circuit provided in the distributed data transfer control device 1, for example. The storage unit 1a stores, for example, a communication speed between the distributed data transfer control device 1 and each of servers 3 and 4. A time (delay time) required to acquire data in a unit data volume from each of the servers 3 and 4 may be stored in the storage unit 1a instead of the communication speed. In the example in FIG. 1, the server 3 is disposed closer to the distributed data transfer control device 1 than the server 4, and thus a communication speed a with the server 3 is faster than a communication speed b with the server 4.

The distributed data transfer control device 2 includes a storage unit 2a and a processing unit 2b in order to realize the distributed data transfer control method. The storage unit 2a is a memory or a storage device provided in the distributed data transfer control device 2, for example. The processing unit 2b is a processor or an arithmetic operation circuit provided in the distributed data transfer control device 2, for example. The storage unit 2a stores, for example, a communication speed between the distributed data transfer control device 2 and each of servers 3 and 4. A time (delay time) required to acquire data in a unit data volume from each of the servers 3 and 4 may be stored in the storage unit 2a instead of the communication speed. In the example in FIG. 1, the server 4 is disposed closer to the distributed data transfer control device 2 than the server 3, and thus a communication speed d with the server 4 is faster than a communication speed c with the server 3.

The distributed data transfer control devices 1 and 2 are coupled to the servers 3 and 4 and a management server 5 via a network 10. Pieces of data 3a and 4a having the same content are distributed and stored in the servers 3 and 4. The management server 5 manages distributed storage destinations of the pieces of data 3a and 4a.

The distributed data transfer control device 1 is coupled to a base station 6 in a wireless communication. The distributed data transfer control device 2 is coupled to a base station 7 in a wireless communication. A communication available range 6a of the base station 6 is adjacent to a communication available range 7a of the base station 7.

Mobile terminals 8 and 9 used by users communicate with the distributed data transfer control devices 1 and 2 through the base stations 6 and 7 and acquire the pieces of data 3a and 4a from any of the servers 3 and 4. For example, the mobile terminals 8 and 9 acquire data through the distributed data transfer control device 1 in the communication available range 6a of the base station 6 and acquire data through the distributed data transfer control device 2 in the communication available range 7a of the base station 7.

The mobile terminals 8 and 9 transmit a data acquisition request to the distributed data transfer control device 1 or the distributed data transfer control device 2 based on an input of a data acquisition instruction from the user, for example. At this time, the mobile terminals 8 and 9 includes a first list in the data acquisition request in a case of having the first list indicating at least some of the plurality of servers 3 and 4 as a data retention server.

The distributed data transfer control devices 1 and 2 acquire data from the server 3 or the server 4 based on the data acquisition request from the mobile terminals 8 and 9 and transmit the acquired data to the mobile terminals 8 and 9. If receiving the data acquisition request, the distributed data transfer control devices 1 and 2 perform a process in accordance with the presence or absence of the first list or a movement tendency of the mobile terminals 8 and 9. For example, the distributed data transfer control devices 1 and 2 perform a process as follows.

The distributed data transfer control devices 1 and 2 receive a data acquisition request of data retained by the plurality of servers 3 and 4, from the mobile terminals 8 and 9 wirelessly coupled to the base station 6 in the wireless communication. Receiving the data acquisition request, the distributed data transfer control devices 1 and 2 determine whether or not the first list indicating at least some of the plurality of servers 3 and 4 as the data retention server is included in the data acquisition request. In a case where the first list is not included, the distributed data transfer control devices 1 and 2 acquire a second list from the management server 5. The second list indicates the plurality of servers 3 and 4 as the data retention server. The distributed data transfer control devices 1 and 2 select one of data retention servers indicated in the first list or the second list as an acquisition destination server from which data is to be acquired, based on a communication speed with each of the data retention servers. The distributed data transfer control devices 1 and 2 acquire data from the acquisition destination server.

The distributed data transfer control devices 1 and 2 acquire the current positions, the movement directions, and the movement speeds of the mobile terminals 8 and 9. For example, the mobile terminals 8 and 9 include the current position, the movement direction, and the movement speed of the own terminal in the data acquisition request. In this case, the distributed data transfer control device 1 or 2 may acquire the current position, the movement direction, and the movement speed of the mobile terminal 8 or 9 from the received data acquisition request. The distributed data transfer control device 1 or 2 determines whether or not data acquisition of the mobile terminal 8 or 9 is enabled to be completed in a period in which the mobile terminal 8 or 9 stays in the communication available range 6a or 7a which is the same as that when transmitting the data acquisition request, based on the above pieces of information and the data size of data as an acquisition target. In a case where it is determined that acquisition of data is enabled to be completed, the distributed data transfer control device 1 or 2 creates a third list indicating the acquisition destination server as the data retention server. In a case where it is determined that completion of the acquisition of data is not possible, the distributed data transfer control device 1 or 2 creates a fourth list indicating two or more of the plurality of servers indicated in the second list, as the data retention server. The distributed data transfer control device 1 or 2 transmits the data, and the third list or the fourth list to the mobile terminal 8 or 9 that has transmitted the data acquisition request.

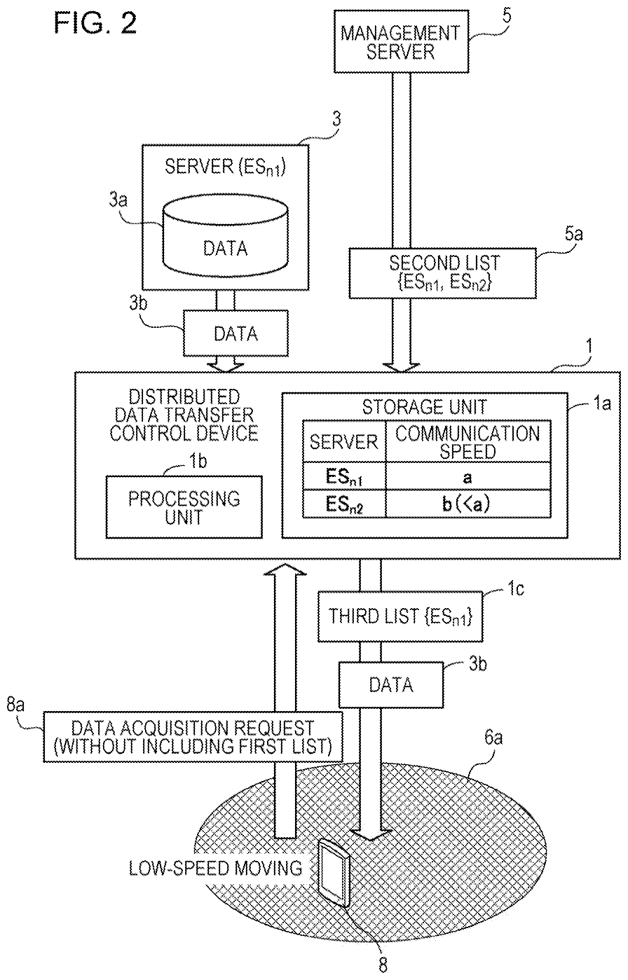

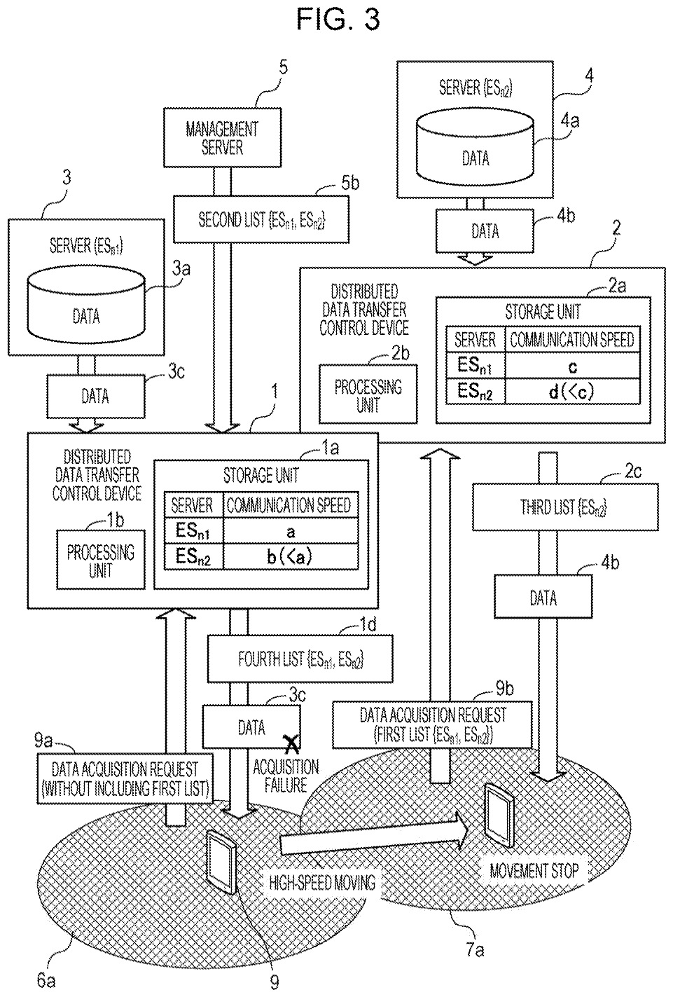

In this manner, contents of the list to be transmitted to the mobile terminal 8 or 9 are determined in accordance with a movement tendency of the mobile terminal 8 or 9. For example, it is assumed that the mobile terminal 8 moves at a low speed. It is assumed that the mobile terminal 9 moves at a high speed. Processing of the distributed data transfer control devices 1 and 2 when each of the mobile terminals 8 and 9 transmits the data acquisition request will be described below in detail with reference to FIGS. 2 and 3.

FIG. 2 is a diagram illustrating a first example of processing in response to the data acquisition request. FIG. 2 illustrates processing in a case where the mobile terminal 8 moving at a low speed in the communication available range 6a of the base station 6 transmits a data acquisition request 8a. The data acquisition request 8a does not include the first list.

If the processing unit 1b of the distributed data transfer control device 1 receives the data acquisition request 8a, the processing unit 1b determines that the first list is not included in the data acquisition request 8a and acquires a second list 5a from the management server 5. An identifier (ESₙ₁, ESₙ₂) of each of the servers 3 and 4 is included in the second list 5a as an identifier of the data retention server. The processing unit 1b recognizes that the servers 3 and 4 retain the pieces of data 3a and 4a, based on the second list 5a. The processing unit 1b refers to the storage unit 1a to select the server 3 having a faster communication speed (time required to acquire data is shorter) among the servers 3 and 4, as the acquisition destination server. The processing unit 1b acquires the data 3b from the server 3.

The processing unit 1b determines whether or not the mobile terminal 8 is capable of completing acquisition of data in a period in which the mobile terminal 8 stays in the communication available range 6a of the base station 6, based on the current position, the movement direction, and the movement speed of the mobile terminal 8 and the data size of the data. In the example in FIG. 2, the movement speed of the mobile terminal 8 is low, and thus it is predicted that the mobile terminal 8 stays in the communication available range 6a of the base station 6 until completing a data acquisition process in response to the data acquisition request 8a. If the mobile terminal 8 stays in the communication available range 6a, a possibility that the data acquisition request is transmitted to the distributed data transfer control device 1 even in a case where a data acquisition request of the same data is transmitted from the mobile terminal 8 after that is low. The processing unit 1b creates a third list 1c indicating the acquisition destination server (server 3) as the data retention server. The processing unit 1b transmits the data 3b acquired from the server 3 and the third list 1c to the mobile terminal 8.

FIG. 3 is a diagram illustrating a second example of the processing in response to the data acquisition request. FIG. 3 illustrates processing in a case where the mobile terminal 9 moving at a high speed in the communication available range 6a of the base station 6 transmits a data acquisition request 9a. The data acquisition request 9a does not include the first list.

If the processing unit 1b of the distributed data transfer control device 1 receives the data acquisition request 9a, the processing unit 1b determines that the first list is not included in the data acquisition request 9a and acquires a second list 5b from the management server 5. An identifier (ESₙ₁, ESₙ₂) of each of the servers 3 and 4 is included in the second list 5b as an identifier of the data retention server. The processing unit 1b recognizes that the servers 3 and 4 retain the pieces of data 3a and 4a, based on the second list 5b. The processing unit 1b refers to the storage unit 1a to select the server 3 having a faster communication speed (time required to acquire data is shorter) among the servers 3 and 4, as the acquisition destination server. The processing unit 1b acquires the data 3c from the server 3.

The processing unit 1b determines whether or not the mobile terminal 9 is capable of completing acquisition of data in a period in which the mobile terminal 9 stays in the communication available range 6a of the base station 6, based on the current position, the movement direction, and the movement speed of the mobile terminal 9 and the data size of the data. In the example in FIG. 3, the movement speed of the mobile terminal 9 is high, and thus it is predicted that the mobile terminal 9 becomes out of the communication available range 6a of the base station 6 before completing the data acquisition process in response to the data acquisition request 9a. If the mobile terminal 9 goes out of the communication available range 6a, data acquisition fails and ends. There is a high possibility that the mobile terminal 9 transmits a data acquisition request to another distributed data transfer control device 2 again. The processing unit 1b creates a fourth list 1d indicating the plurality of servers 3 and 4 indicated in the second list 5b, as the dab retention server. The processing unit 1b transmits the data 3c acquired from the server 3 and the fourth list 1d to the mobile terminal 9.

The fourth list 1d is transmitted without waiting for completion of transmitting the data 3c. The fourth list 1d has a data volume smaller than that of the data 3c. Thus, the mobile terminal 9 is capable of completing acquisition of the fourth list 1d even in a case where it is not possible to complete the acquisition of the data 3c, The mobile terminal 9 stores the acquired fourth list 1d in an internal memory or an internal storage device.

In the example in FIG. 3, the mobile terminal 9 is set to go out of the communication available range 6a of the base station 6 and then enter into the communication available range 7a of the base station 7, before acquisition of the data 3c is completed. In this case, the mobile terminal 9 transmits a data acquisition request 9b to the distributed data transfer control device 2. At this time, the mobile terminal 9 includes the first list having the same contents as those of the fourth list 1d acquired from the distributed data transfer control device 1, in the data acquisition request 9b.

If the processing unit 2b of the distributed data transfer control device 2 receives the data acquisition request 9b, the processing unit 2b determines that the first list is included in the data acquisition request 9b. The processing unit 2b recognizes that the servers 3 and 4 retain the pieces of data 3a and 4a, based on the first list included in the data acquisition request 9b. The processing unit 2b refers to the storage unit 2a to select the server 4 having a faster communication speed (time required to acquire data is shorter) among the servers 3 and 4, as the acquisition destination server. The processing unit 2b acquires data 4b from the server 4.

The processing unit 2b determines whether or not the mobile terminal 9 is capable of completing acquisition of data in a period in which the mobile terminal 9 stays in the communication available range 7a of the base station 7, based on the current position, the movement direction, and the movement speed of the mobile terminal 9 and the data size of the data. In the example in FIG. 3, it is predicted that the mobile terminal 9 suspends movement after entering into the communication available range 7a, and the mobile terminal 9 stays in the communication available range 7a of the base station 7 until the data acquisition process in response to the data acquisition request 9b is completed. The processing unit 2b creates a third list 2c indicating the acquisition destination server (server 4) as the data retention server. The processing unit 2b transmits the data 4b acquired from the server 4 and the third list 2c to the mobile terminal 9.

As illustrated in FIGS. 2 and 3, in a case where it may be predicted that data acquisition is completed by the mobile terminal 8 or 9, based on the position, the movement direction, and the movement speed of the mobile terminal 8 or 9 and the data size, it is possible to reduce the data volume of the list retained by the mobile terminals 8 and 9.

When the first list is included in the data acquisition request, the mobile terminals 8 and 9 may further include previous request destination information in the data acquisition request. The previous request destination information indicates a device that has provided the first list for the mobile terminal. In this case, the processing units 1b and 2b of the distributed data transfer control devices 1 and 2 determine whether or not the first list is valid, based on the number of data retention servers indicated in the first list and the previous request destination information. For example, in a case where the number of servers indicated in the first list is one, and a device that has provided the first list for the mobile terminal is the distributed data transfer control device 1, or in a case where the number of servers indicated in the first list is two or more, the processing unit 1b determines that the first list is valid. In other cases, the processing unit 1b determines that the first list is not valid. Similarly, in a case where the number of servers indicated in the first list is one, and a device that has provided the first list for the mobile terminal is the distributed data transfer control device 2, or in a case where the number of servers indicated in the first list is two or more, the processing unit 2b determines that the first list is valid. In other cases, the processing unit 2b determines that the first list is not valid.

In a case where the first list is not valid, the processing units 1b and 2b acquire the second list from the management server 5. In a case where the first list is not valid, the processing units 1b and 2b acquire data from the server having the fastest communication speed among the data retention servers, based on the communication speed with each of the data retention servers indicated in the second list.

As described above, since validity of the first list is determined, it is possible to acquire the second list from the management server 5 in a case where the mobile terminal 8 or 9 erroneously determines whether or not completion of data acquisition is possible, and to acquire data from the server having the fastest communication speed (delay time is shortest).

For example, in the example in FIG. 2, contrary to expectations, the mobile terminal 8 may go out of the communication available range 6a before the acquisition of the data 3b is completed. In this case, the mobile terminal 8 transmits a data acquisition request again. The data acquisition request transmitted at this time is transmitted not to the distributed data transfer control device 1 but to the distributed data transfer control device 2, for example. If the data acquisition request is transmitted again, even though the first list having the same contents as those of the third list acquired from the distributed data transfer control device 1 is included in the data acquisition request transmitted again by the mobile terminal 8, the server Indicated in the first list is not limited to having the fastest communication speed with the distributed data transfer control device 2. The processing unit 2b of the distributed data transfer control device 2 sets the first list to be invalid even though receiving the first list having the same contents as those of the third list acquired from the distributed data transfer control device 1, from the mobile terminal 8. Thus, an occurrence of a situation in which data is acquired from a server having a slow communication speed with the distributed data transfer control device 2, and a data acquisition time becomes long is suppressed.

When the processing units 1b and 2b of the distributed data transfer control devices 1 and 2 determine whether or not completion of acquisition of data is possible, the processing units 1b and 2b calculate a data acquisition completion estimated position indicating the position of the mobile terminal at a time at which acquisition of data is completed, for example. The processing units 1b and 2b calculate the data acquisition completion estimated position, for example, based on the current position, the movement direction, and the movement speed of the mobile terminal 8 or 9 and the data size of the data. The processing units 1b and 2b determine whether or not completion of acquisition of the data is possible, based on whether or not the data acquisition completion estimated position is within the communication available range 6a or 7a of the base station 6 or 7 coupled to the distributed data transfer control devices 1 and 2. As described above, if the data acquisition completion estimated position is calculated based on movement situations of the mobile terminals 8 and 9 and the data size of data, and it is determined whether or not completion of acquisition of data is possible, it is possible to perform accurate determination.

The processing units 1b and 2b of the distributed data transfer control devices 1 and 2 may create the fourth list indicating a server present in a direction within a predetermined angle from the current positions of the mobile terminals 8 and 9 to the movement directions of the mobile terminals, as the data retention server. Thus, the server present in a direction (for example, opposite direction) which is completely different from the movement directions of the mobile terminals 8 and 9 is not included in the fourth list, and thus it is possible to reduce the data volume of the fourth list.

The processing units 1b and 2b of the distributed data transfer control devices 1 and 2 may create the fourth list indicating a server present in a predetermined distance from the current position of the mobile terminal, as the data retention server. Thus, the server which is very far from the current positions of the mobile terminals 8 and 9 is not included in the fourth list, and thus it is possible to reduce the data volume of the fourth list.

The mobile terminals 8 and 9 may include information in the data acquisition request. This information indicates the previous data acquisition source server as an acquisition destination when the mobile terminals 8 and 9 have previously acquired data. In this case, the processing units 1b and 2b of the distributed data transfer control devices 1 and 2 determine whether or not loads of the distributed data transfer control devices 1 and 2 when receiving the data acquisition request exceed a predetermined value. In a case where the load exceeds the predetermined value, the processing units 1b and 2b suspend an acquisition process of the second list and acquire data from the previous data acquisition source server. Thus, it is possible to suppress an occurrence of a situation in which time to acquire data becomes long due to overloading of the distributed data transfer control devices 1 and 2.

### Second Embodiment

Next, a second embodiment will be described. Regarding the position of the device, a case of a geographical position and a case of a position in a coupling relation over the network are provided. In a case of simply referring to the position, it is assumed below that the position means a geographical position.

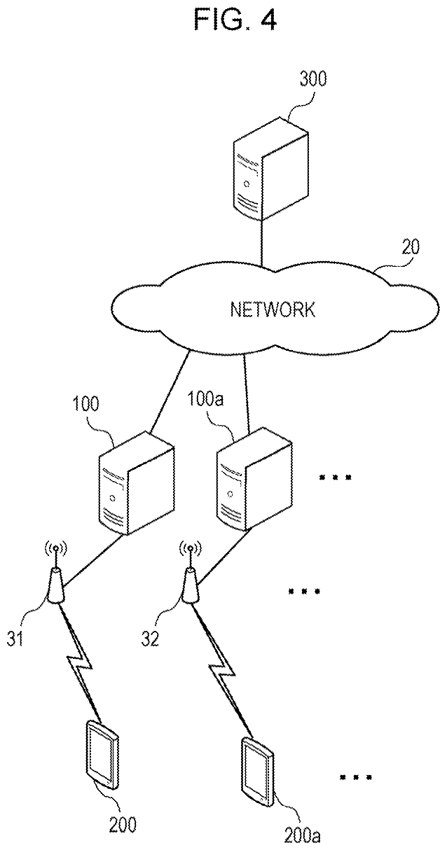

FIG. 4 is a diagram illustrating an example of a system configuration according to a second embodiment. ESs 100, 100a, are coupled to a center server 300 via a network 20. The center server 300 is a computer that retains data provided for UEs 200, 200a, . . . used by users. The ESs 100, 100a, are computers that receive a data acquisition request from the UEs 200, 200a, . . . , acquire data in response to the data acquisition request, and transmit the acquired data to the UEs 200, 200a, . . . .

At least some ESs retain a copy of data provided by the center server 300. If the ESs 100, 100a, . . . receive a data acquisition request from the UEs 200, 200a, . . . , each of the ESs 100, 100a, . . . acquire the data from the closest ES that retains the required data and transmit the acquired data to the UE as a transmission source of the data acquisition request.

Access points (APs) 31, 32, . . . are coupled to the ESs 100, 100a, . . . , respectively. The APs 31, 32, are examples of the base station in a wireless communication. The UEs 200, 200a, . . . , perform a wireless communication with the APs 31, 32, . . . by using a radio wave. The UEs 200, 200a, . . . may communicate with the ESs 100, 100a, . . . through the APs 31, 32, . . . .

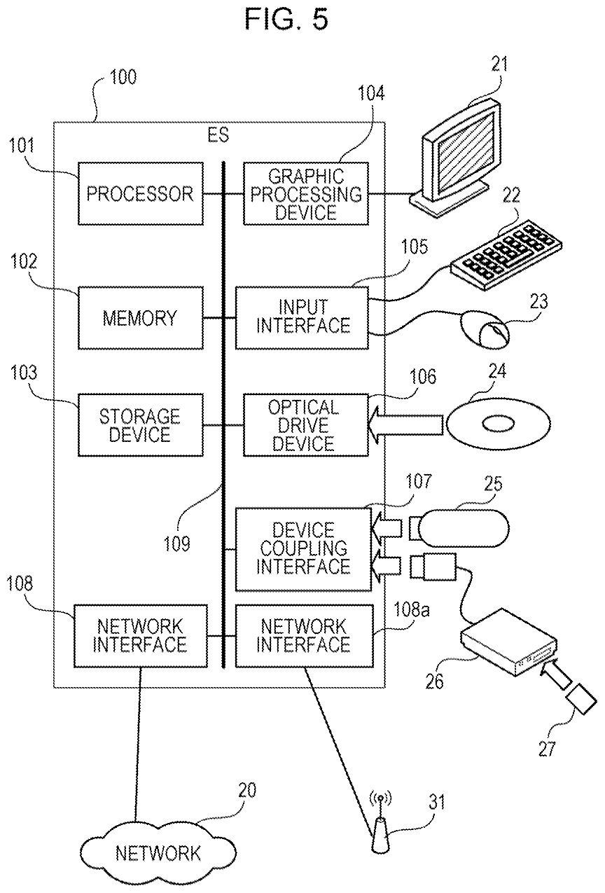

FIG. 5 is a diagram illustrating an example of hardware of the ES. The ES 100 is controlled by a processor 101. A memory 102 and a plurality of peripheral devices are coupled to the processor 101 via a bus 109. The processor 101 may be a multiprocessor. The processor 101 is, for example, a central processing unit (CPU), a microprocessor unit (MPU), or a digital signal processor (DSP). At least some of functions implemented by the processor 101 executing a program may be implemented by an electronic circuit such as an application specific integrated circuit (ASIC) or a programmable logic device (PLD).

The memory 102 is used as a main storage device of the ES 100. The memory 102 temporarily stores at least some of operating system (OS) programs and application programs executed by the processor 101. The memory 102 stores various kinds of data to be used in processing by the processor 101. For example, a volatile semiconductor storage device such as a random-access memory (RAM) is used as the memory 102.

Examples of the peripheral devices coupled to the bus 109 include a storage device 103, a graphic processing device 104, an input interface 105, an optical drive device 106, a device coupling interface 107, and network interfaces 108 and 108a.

The storage device 103 electrically or magnetically writes and reads data to and out from a built-in recording medium. The storage device 103 is used as an auxiliary storage device of the computer. The storage device 103 stores an OS program, an application program, and various kinds of data. For example, a hard disk drive (HDD) or a solid state drive (SSD) may be used as the storage device 103.

A monitor 21 is coupled to the graphic processing device 104, The graphic processing device 104 displays an image on a screen of the monitor 21 in accordance with a command from the processor 101. Examples of the monitor 21 include a display device using an organic electroluminescence (EL) and a liquid crystal display device.

A keyboard 22 and a mouse 23 are coupled to the input interface 105. The input interface 105 transmits a signal transmitted from the keyboard 22 and the mouse 23, to the processor 101. The mouse 23 is an example of a pointing device, and other pointing devices may be used. Examples of the other pointing devices include a touch panel, a tablet, a touch pad, and a trackball.

The optical drive device 106 reads data recorded in an optical disk 24 by using a laser beam and the like. The optical disk 24 is a portable recording medium on which data is recorded to be readable by light reflection. The optical disk 24 includes a digital versatile disc (DVD), a DVD-RAM, a compact disc read-only memory (CD-ROM), CD-Recordable (R)/Rewritable (RW) and the like.

The device coupling interface 107 is a communication interface for coupling the peripheral device to the ES 100. For example, a memory device 25 and a memory reader and writer 26 may be coupled to the device coupling interface 107. The memory device 25 is a recording medium having a function of communicating with the device coupling interface 107. The memory reader and writer 26 is a device that writes data to a memory card 27 or reads data from the memory card 27. The memory card 27 is a card-type recording medium.

The network interface 108 is coupled to the network 20. The network interface 108 transmits and receives data to and from another computer or communication equipment via the network 20.

The network interface 108a is coupled to the AP 31. The network interface 108a transmits and receives data to and from the UEs 200, 200a, . . . through the AP 31.

With the hardware configuration described above, the ES 100 may implement processing functions in the second embodiment. Other ES 100a, . . . or the center server 300 may also be realized by hardware similar to that of the ES 100 illustrated in FIG. 5. The distributed data transfer control devices 1 and 2 described in the first embodiment may also be realized by hardware similar to that of the ES 100 illustrated in FIG. 5.

For example, the ES 100 implements the processing functions in the second embodiment by executing a program recorded in a computer-readable recording medium. A program in which contents of processing to be executed by the ES 100 are described may be recorded in various recording media. For example, the program to be executed by the ES 100 may be stored in the storage device 103. The processor 101 loads at least a part of the program in the storage device 103 into the memory 102, and executes the program. The program to be executed by the ES 100 may be recorded in a portable recording medium such as the optical disk 24, the memory device 25, or the memory card 27. For example, the program stored in the portable recording medium may be executed after the program is installed on the storage device 103 under the control of the processor 101, The processor 101 may directly read out the program from the portable recording medium and execute the program.

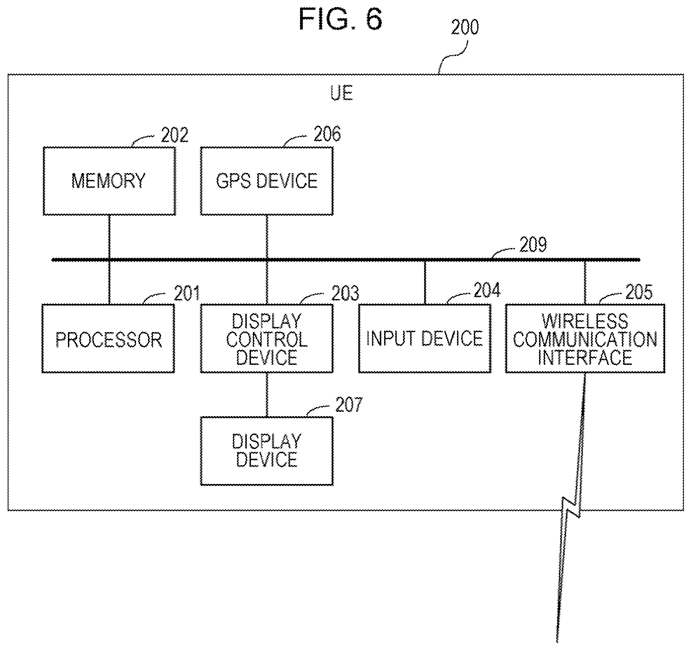

FIG. 6 is a diagram illustrating an example of hardware of the UE. The UE 200 is entirely controlled by a processor 201. A memory 202 and a plurality of peripheral devices are coupled to the processor 201 via a bus 209. The processor 201 may be a multiprocessor. The processor 201 is a CPU, an MPU, or a DSP, for example. At least some functions of the processor 201 may be implemented by an electronic circuit such as an ASIC or a PLD.

The memory 202 is used as a main storage device of the UE 200. The memory 202 temporarily stores an OS program or an application program to be executed by the processor 201. The memory 202 stores various kinds of data to be desirable for processing by the processor 201.

Examples of the peripheral devices coupled to the bus 209 include a display control device 203, an input device 204, a wireless communication interface 205, and a Global Positioning System (GPS) device 206.

A display device 207 is coupled to the display control device 203. The display control device 203 displays an image on a screen of the display device 207 in accordance with a command from the processor 201. For example, the display device 207 is a liquid crystal display device.

The input device 204 is a device that performs an input to the UE 200. For example, a touch panel provided on the front surface of the screen of the display device 207 is provided as the input device 204. The input device 204 detects a touch on the touch panel with a part of a user such as a finger and transmits a signal indicating the touched position to the processor 201.

The wireless communication interface 205 controls a wireless communication. The wireless communication interface 205 communicates with the APs 31, 32, . . . by the wireless communication, for example.

The GPS device 206 receives time point information from a GPS satellite by a built-in GPS antenna and calculates coordinates (latitude and longitude) of the current location. The coordinates of the current location calculated by the GPS device 206 are transmitted to the processor 201 and are used to determine the current position, to calculate the movement speed, and the like.

With the hardware configuration described above, the UE 200 may implement processing functions in the second embodiment, Other UE 200a, . . . may also be realized by hardware similar to that of the UE 200 illustrated in FIG. 6. The mobile terminals 8 and 9 described in the first embodiment may be also realized by the same hardware as that of the UE 200 illustrated in FIG. 6.

Next, a basic flow of the data acquisition process by the UEs 200, 200a, . . . will be described. In the data acquisition process, first acquisition of data is different from second and the subsequent acquisition in the UE that acquires the data.

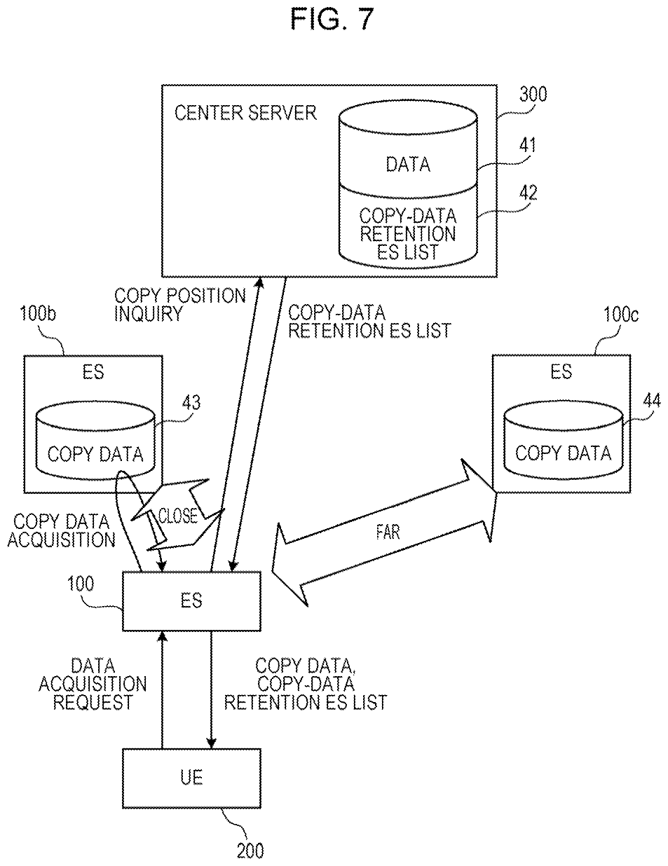

FIG. 7 is a diagram illustrating an example of a first data acquisition process. In the example in FIG. 7, copies (copy data 43 and 44) of data 41 as a transfer target to be provided by the center server 300 are retained by ESs 100b and 100c. A copy-data retention ES list 42 is stored in the center server 300, The copy-data retention ES list 42 indicates an ES that retains the copy data 43 or 44 of the data 41.

When a user of the UE 200 attempts to use the data 41, the user inputs an acquisition instruction of the data 41 to the UE 200. If the user performs the input, the UE 200 transmits a data acquisition request of designating the data 41 to the ES 100 capable of being coupled at this time. At this time point, the ES 100 does not recognize an ES that retains the copy data 43 or 44 of the data 41 among the ESs 100b and 100c. The ES 100 transmits a copy position inquiry of designating the data 41 to the center server 300. The center server 300 transmits a copy-data retention ES list 42 corresponding to the data 41 to the ES 100 in response to the copy position inquiry.

The ES 100 recognizes that the ESs 100b and 100c respectively retain the pieces of copy data 43 and 44, based on the acquired copy-data retention ES list 42. The ES 100 acquires copy data from the ES having a shorter data transfer time to the ES 100 among the ESs 100b and 100c. In the example in FIG. 7, it is assumed that, among the ESs 100b and 100c, the ES 100b is disposed closer to the ES 100 than the ES 100c, and a data transfer speed to the ES 100 is faster. The ES 100 acquires the copy data 43 from the ES 100b, The ES 100 transmits the copy data 43 acquired from the ES 100b, to the UE 200 as a response to the data acquisition request. The ES 100 includes the copy-data retention ES list in the response. This copy-data retention ES list includes at least some of ES identifiers indicated in the copy-data retention ES list 42 acquired from the center server 300. In a case where a process of reducing the data volume of the copy-data retention ES list is not applied in the second embodiment, all ES identifiers indicated in the copy-data retention ES list 42 are included in the copy-data retention ES list included in the response.

The UE 200 stores the acquired copy-data retention ES list and uses the copy-data retention ES list for the next acquisition of the data 41.

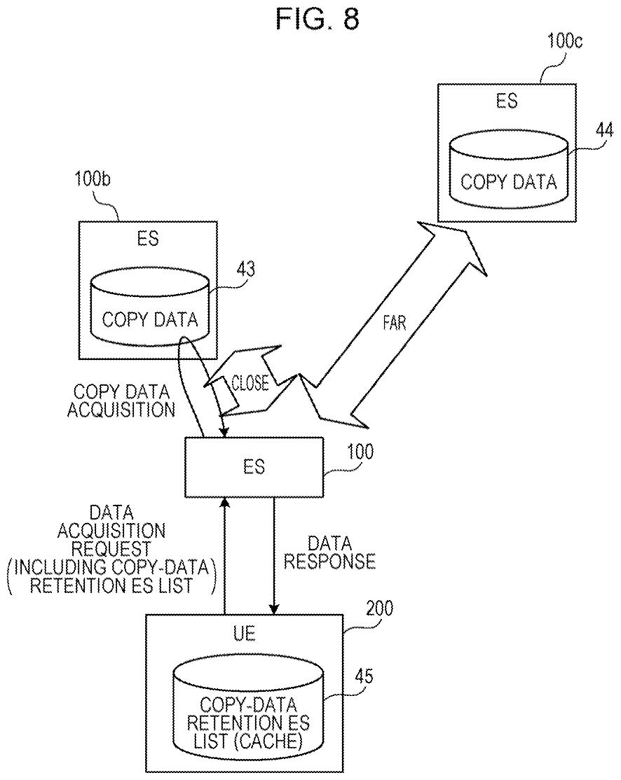

FIG. 8 is a diagram illustrating an example of a second and the subsequent data acquisition process. A copy-data retention ES list 45 is stored in the UE 200. In the example in FIG. 8, the UE 200 is still at a position at which the UE 200 is capable of being coupled to the ES 100. When the user of the UE 200 attempts to use the data 41 again in this state, for example, the user inputs an acquisition instruction of the data 41 to the UE 200. The UE 200 transmits a data acquisition request including the copy-data retention ES list 45 to the ES 100.

The ES 100 refers to the acquired copy-data retention ES list 45 to determine that the ES 100b has the shortest data transfer speed among the ESs 100b and 100c having copy data of the data 41. The ES 100 acquires the copy data 43 from the ES 100b. The ES 100 transmits the copy data 43 acquired from the ES 100b to the UE 200 as a response to the data acquisition request.

As described above, since the UE 200 as a data acquisition source caches the copy-data retention ES list 45 regarding data acquired by the UE 200, it is possible to reduce the number of copy position inquiries from the center server 300. If the UE 200 caches the copy-data retention ES list 42 itself retained by the center server 300, there is a problem in that the cache size for retaining the copy-data retention ES list 45 increases in the UE 200.

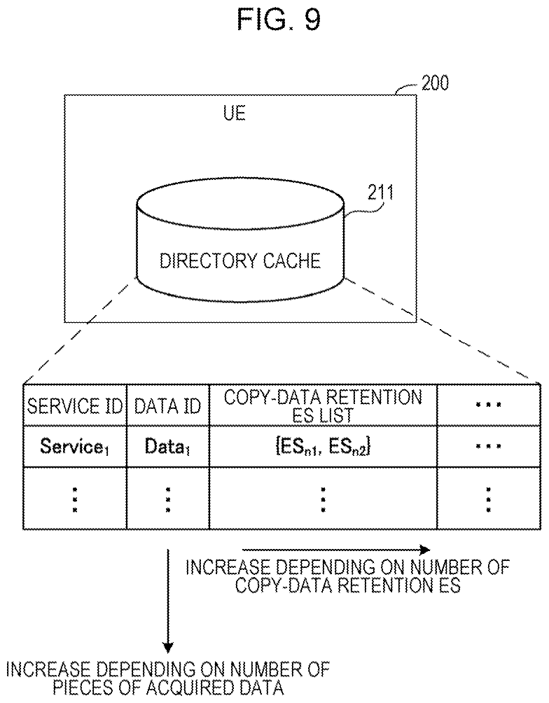

FIG. 9 is a diagram illustrating a reason of increasing the cache size. For example, the UE 200 retains a copy-data retention ES list for each piece of data, in a directory cache 211, A record of each piece of data acquired by the UE 200 is registered in the directory cache 211. For example, information such as a service ID, a data ID, and a copy-data retention ES list is included in each record.

As data registered in the center server 300 is diversified, and time elapses, the types (contents) of data registered in the center server 300 increase. It is assumed that the UE 200 uses various kinds of data registered in the center server 300.

The size of the directory cache 211 in the UE 200 increases in accordance with the type of data acquired by the UE 200. The size of the directory cache 211 also increases in accordance with the length of the copy-data retention ES list.

It is possible to suppress an increase of the size of the directory cache 211 in accordance with the type of data acquired by the UE 200, by deleting a record in which an inquiry time point of the copy-data retention ES list is old, for example. It is difficult to suppress the increase of the size of the directory cache 211 in accordance with the length of the copy-data retention ES list, only by the determination of the UE 200.

In a case where a plurality of UEs acquire common data, caching the copy-data retention ES list having the same contents relating to the data is too redundant for the entire system.

In the second embodiment, the ES 100 that receives the data acquisition request from the UE 200 reduces the size of the copy-data retention ES list if possible, before the ES 100 transfers the copy-data retention ES list to the UE 200. For example, the ES 100 determines whether or not reduction of the size of the copy-data retention ES list is possible, based on the movement tendency of the UE 200 as a transmission source of the data acquisition request and the size of the required data.

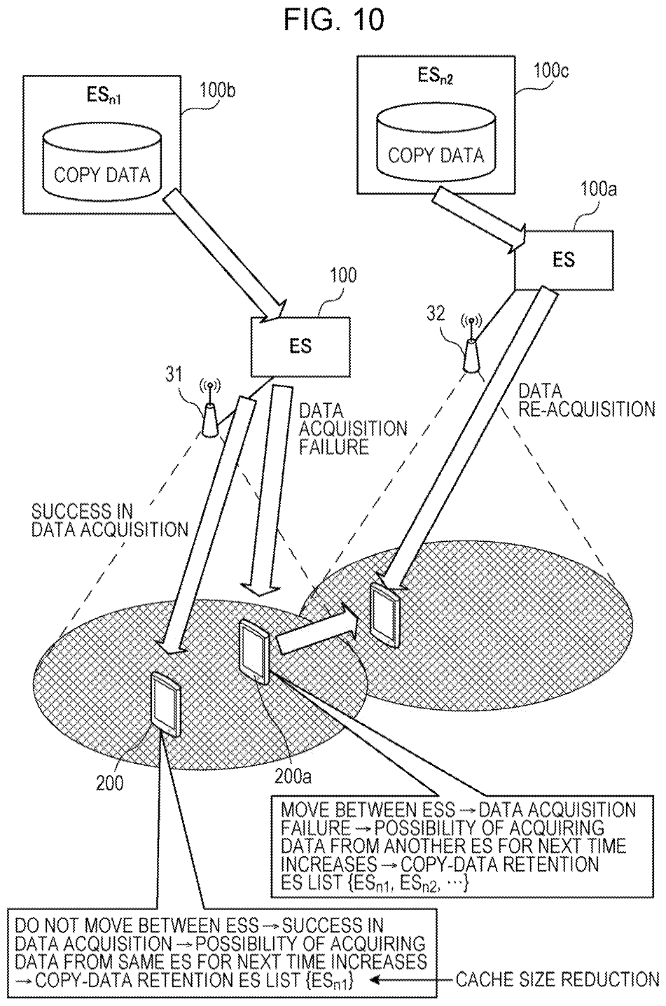

FIG. 10 is a diagram illustrating a determination example of reducing the size of the copy-data retention ES list. In the example in FIG. 10, the ES identifier of the ES 100b is “ESₙ₁”, and the ES identifier of the ES 100c is “ESₙ₂”, The two UEs 200 and 200a are within a communication range of the AP 31 coupled to the ES 100. The UE 200 is set to move hardly. The UE 200a is set to move at a high speed.

If the UE 200 transmits the data acquisition request to the ES 100, the ES 100 determines whether or not the UE 200 stays in the communication range of the AP 31 until data acquisition is completed, based on the position and the movement speed of the UE 200 and the data size of the required data. In the example in FIG. 10, the UE 200 does not move, and it is determined that the UE 200 stays in the communication range of the AP 31. In a case where the UE 200 succeeds in data acquisition, a possibility that the UE 200 acquires data from the same ES 100 the next time is high. The ES 100 transmits a copy-data retention ES list including only the ES identifier “ESₙ₁” of the ES 100b enabling the ES 100 to acquire copy data in the shortest time, to the UE 200.

If the UE 200a transmits the data acquisition request to the ES 100, the ES 100 determines whether or not the UE 200a stays in the communication range of the AP 31 until data acquisition is completed, based on the position and the movement speed of the UE 200a and the data size of the required data. In the example in FIG. 10, it is assumed that the UE 200a goes out of the communication range of the AP 31 coupled to the ES 100 and enters into a communication range of the AP 32 coupled to the ES 100a, until data acquisition is completed. The ES 100 determines that the UE 200a does not stay in the communication range of the AP 31. If the UE 200a does not stay in the communication range of the AP 31, acquisition of the copy data by the UE 200a through the ES 100 fails and ends.

In a case where the UE 200a fails in data acquisition, a possibility that the UE 200a acquires data from another ES 100a for the next time is high. The ES 100 transmits a copy-data retention ES list including the ES identifiers “ESₙ₁” and “ESₙ₂” of all the ESs 100b and 100c that retain copy data, to the UE 200a.

If the data acquisition fails and ends, the UE 200a transmits a data acquisition request again. In retransmission, the UE 200a moves and enters into the communication range of the AP 32 for the ES 100a. Therefore, the UE 200a transmits the data acquisition request including a copy-data retention ES list in which the ES identifiers “ESₙ₁” and “ESₙ₂” of all the ESs 100b and 100c that retain copy data are provided, to the ES 100a, The ES 100a that receives the data acquisition request recognizes the ESs 100b and 100c that retain copy data, based on the copy-data retention ES list. The ES 100a acquires the copy data from the ES 100c having a shorter acquisition time of the copy data among the Bs 100b and 100c, and transmits the acquired copy data to the UE 200a.

Thus, for the UE 200 which does not move between the ESs during acquisition of copy data, it is possible to reduce the size (cache size) of the copy-data retention ES list. In a case where the UE 200 acquires the same data again, the UE 200 transmits a data acquisition request including a copy-data retention ES list indicating the ES identifier “ESₙ₁” of the ES 100b, to the ES 100. Thus, the ES 100 acquires copy data from the ES 100b based on the copy-data retention ES list and transmits the acquired copy data to the UE 200. The ES 100b as an acquisition source of the copy data at this time is capable of acquiring the copy data for a shorter time than the ES 100c. Even though the size of the copy-data retention ES list is reduced, deterioration of acquisition efficiency of data is suppressed.

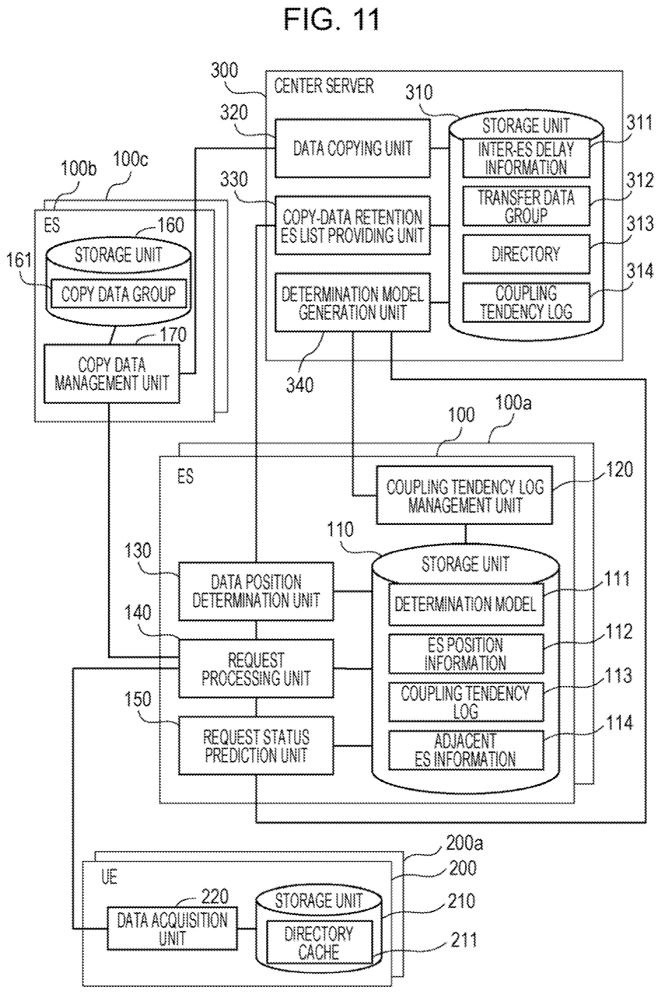

A function of each device for realizing such reduction of the size of the copy-data retention ES list will be described with reference to FIG. 11.

FIG. 11 is a block diagram illustrating functions of each device. In the example in FIG. 11, it is assumed that the Bs 100b and 100c retain copy data of data as a transfer target, and the ESs 100 and 100a receive a data acquisition request from the UEs 200 and 200a.

The center server 300 includes a storage unit 310, a data copying unit 320, a copy-data retention ES list providing unit 330, and a determination model generation unit 340.

The storage unit 310 stores various kinds of data distributed to other devices and various kinds of data collected from other devices. For example, the storage unit 310 stores inter-ES delay information 311, a transfer data group 312, a directory 313, and a coupling tendency log 314. For example, a part of a storage region of the memory or the storage device of the center server 300 is used as the storage unit 310.

The inter-ES delay information 311 is information regarding a communication speed between two ESs. The inter-ES delay information 311 is used for determining a time required when the ES receiving a data acquisition request acquires copy data from the ES that retains copy data. The transfer data group 312 is a group of pieces of data as the transfer target. The directory 313 is a copy-data retention ES list of each piece of data as the transfer target. The coupling tendency log 314 is various kinds of observation data when the UE acquires copy data.

The data copying unit 320 transmits copy data of data as the transfer target in the transfer data group to the ES 100b or 100c. A transmission destination of the copy data is designated in advance by an administrator for each piece of data as the transfer target, for example.

The copy-data retention ES list providing unit 330 provides the copy-data retention ES list in response to a copy position inquiry from the ES 100 or 100a. For example, the copy-data retention ES list providing unit 330 acquires a copy-data retention ES list corresponding to a data ID from the directory 313, based on the data ID of data as the transfer target indicated in the copy position inquiry. The copy-data retention ES list providing unit 330 transmits the acquired copy-data retention ES list to the ES as a transmission source of the copy position inquiry.

The determination model generation unit 340 generates a determination model for each of the ESs 100 and 100a, based on the coupling tendency log 314, The determination model is information indicating communication available ranges of the APs 31 and 32 coupled to the ESs 100 and 100a. The determination model is used when each of the ESs 100 and 100a determines whether or not data acquisition of the UE 200 or 200a is completed. For example, the determination model generation unit 340 acquires a coupling tendency log 113 from the ES 100 and adds the acquired contents to the coupling tendency log 314 in the storage unit 310. The determination model generation unit 340 generates a determination model indicating the communication available range of the AP 31 coupled to the ES 100, based on the coupling tendency log 113 acquired from the ES 100. The determination model generation unit 340 transmits the generated determination model to the ES 100.

The ES 100b includes a storage unit 160 and a copy data management unit 170.

The storage unit 160 stores a copy data group 161 of data as the transfer target, which is provided by the center server 300. For example, a part of a storage region of the memory or the storage device of the ES 100b is used as the storage unit 160.

The copy data management unit 170 manages the copy data group 161. For example, if receiving copy data from the center server 300, the copy data management unit 170 stores the received copy data in the storage unit 160. If receiving a copy data acquisition request from the ES 100 or 100a, the copy data management unit 170 transmits copy data to the ES as a transmission source of the copy data acquisition request.

FIG. 11 illustrates the functions of the ES 100b, but another ES 100c that retains copy data also has functions similar to those of the ES 100b.

The ES 100 includes a storage unit 110, a coupling tendency log management unit 120, a data position determination unit 130, a request processing unit 140, and a request status prediction unit 150.

The storage unit 110 stores information used for transmitting copy data and the copy-data retention ES list to the UE 200 or 200a. For example, the storage unit 110 stores a determination model 111, ES position information 112, the coupling tendency log 113, and adjacent ES information 114. For example, a part of a storage region of the memory 102 or the storage device 103 of the ES 100 is used as the storage unit 110.

The determination model 111 is information indicating the communication available range of the AP 31 coupled to the ES 100. The ES position information 112 is information indicating the position (latitude and longitude) of each of the ESs 100, 100a, 100b, and 100c. The coupling tendency log 113 is various kinds of observation data when the UE in the communication available range of the AP 31 coupled to the ES 100 acquires copy data. The adjacent ES information 114 is information regarding the communication speed of data between the ES 100 and an ES adjacent to the ES 100.

The coupling tendency log management unit 120 manages the coupling tendency log 113, For example, the coupling tendency log management unit 120 observes a coupling situation in a communication of the UE as a transmission source for each data acquisition request and stores a result of the observation in the storage unit 110 as the coupling tendency log 113. The coupling tendency log management unit 120 transmits the coupling tendency log 113 to the center server 300 at a predetermined timing.

The data position determination unit 130 determines the ES functioning as the acquisition destination of copy data. For example, the data position determination unit 130 acquires the copy-data retention ES list of data as the transfer target, which is designated in the data acquisition request, from the center server 300. Them, the data position determination unit 130 specifies an ES in which an acquisition time of copy data is the shortest among ESs that retain the copy data, based on ESs indicated in the acquired copy-data retention ES list and information regarding the communication speed, which is indicated in the adjacent ES information. The data position determination unit 130 determines the specified ES to be the acquisition destination of the copy data. The data position determination unit 130 may determine the ES functioning as the acquisition destination of the copy data, based on the copy-data retention ES list included in the data acquisition request.

The request processing unit 140 receives the data acquisition request from the UE 200 or 200a and performs processing in response to the data acquisition request. For example, in a case where the copy-data retention ES list is not included in the data acquisition request, the request processing unit 140 inquires an ES functioning as the acquisition destination of copy data from the data position determination unit 130. If the data position determination unit 130 determines the ES as the acquisition destination of the copy data, the request processing unit 140 acquires the copy data from the determined ES.

The request processing unit 140 inquires a result obtained by predicting whether or not the data acquisition request succeeds, from the request status prediction unit 150 based on the current situation of the UE with acquiring copy data. In a case where it is predicted that the data acquisition request succeeds, the request processing unit 140 generates a copy-data retention ES list including only an ES identifier of the ES as the acquisition destination of the copy data. The request processing unit 140 transmits the acquired copy data and the generated copy-data retention ES list to the UE as a transmission source of the data acquisition request. In a case where it is predicted that the data acquisition request does not succeed, the request processing unit 140 transmits the acquired copy data and the copy-data retention ES list acquired from the center server 300 by the data position determination unit 130, to the UE as a transmission source of the data acquisition request.

In a case where the copy-data retention ES list is included in the data acquisition request, the request processing unit 140 acquires copy data from the ES indicated in the copy-data retention ES list. The request processing unit 140 transmits the acquired copy data to the UE as the transmission source of the data acquisition request.

The request status prediction unit 150 predicts whether or not the data acquisition request succeeds, based on the movement tendency of the UE as the transmission source of the data acquisition request and the data size of data to be acquired. In a case where the data acquisition request succeeds, for example, the UE as the transmission source of the data acquisition request may stay in the communication available range of the AP 31 coupled to the ES 100 until acquisition of copy data is completed. In a case where the data acquisition request fails, for example, the UE as the transmission source of the data acquisition request may go out of the communication available range of the AP 31 coupled to the ES 100 until acquisition of copy data is completed. The request status prediction unit 150 determines the communication available range of the AP 31 based on the determination model 111. The determination model 111 may be acquired from the center server 300. For example, the request status prediction unit 150 acquires the determination model 111 from the center server 300 at a predetermined timing and stores the acquired determination model 111 in the storage unit 110.

FIG. 11 illustrates the functions of the ES 100, but another ES 100a that receives a data acquisition request from the UE 200 or 200a also has functions similar to those of the ES 100.

The UE 200 includes a storage unit 210 and a data acquisition unit 220.

The storage unit 210 stores a directory cache 211 including the copy-data retention ES list. For example, a part of a storage region of the memory or the storage device of the UE 200 is used as the storage unit 210.

The data acquisition unit 220 acquires copy data of data as a transfer target, of which an instruction from the user is received. For example, the data acquisition unit 220 transmits a data acquisition request of data as the transfer target to the ES 100. At this time, in a case where a copy-data retention ES list corresponding to data to be acquired is provided in the directory cache 211, the data acquisition unit 220 includes the copy-data retention ES list in the data acquisition request. The data acquisition unit 220 includes information such as position information (latitude and longitude), the movement speed, and the movement direction of the UE 200 and the data size of data to be acquired, in the data acquisition request, for example. The data acquisition unit 220 acquires copy data transmitted from the ES in response to the data acquisition request. If the acquired copy data refers to the content such as an image or a video, the data acquisition unit 220 displays the image and the video based on the copy data, on a display screen of the UE 200. The data acquisition unit 220 may store the acquired copy data in the storage unit 210.

The line coupling between the elements illustrated in FIG. 11 represents a part of communication path, and any communication path other than the illustrated communication path may also be set. The function of each element illustrated in FIG. 11 may be achieved, for example, by causing a computer to execute a program module corresponding to the element.

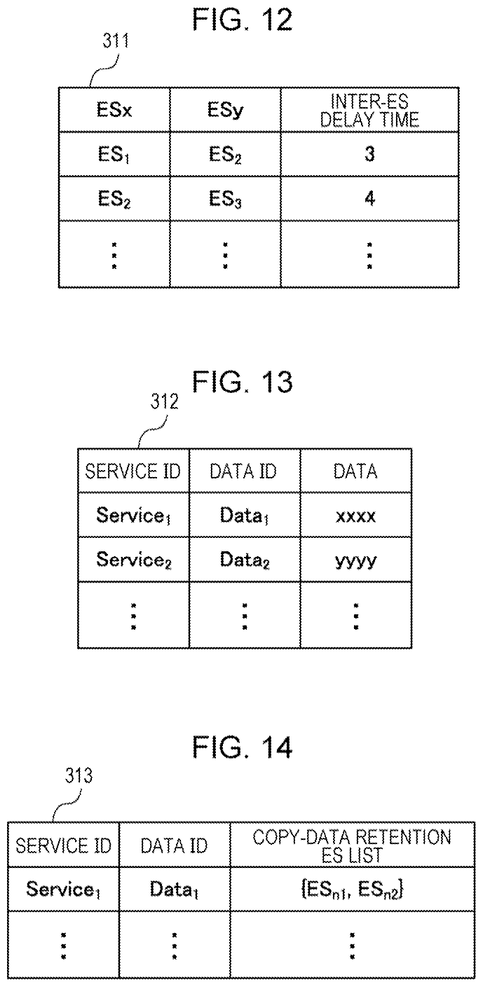

Next, information retained by each device will be described in detail with reference to FIGS. 12 to 20.

FIG. 12 is a diagram illustrating an example of the inter-ES delay information. A delay time (inter-ES delay time) in data transfer between ESs is set in the inter-ES delay information 311 in association with a set of the two ESs (ESₓ, ES_{y}). The inter-ES delay time is a time required to transfer data having a unit data volume between ESs, for example. As a data communication speed between ESs becomes faster, the inter-ES delay time is reduced. For example, in the inter-ES delay information 311 illustrated in FIG. 12, the inter-ES delay time is information regarding the communication speed between ESs.

FIG. 13 is a diagram illustrating an example of the transfer data group. Data as a transfer target is stored in the transfer data group 312 in association with a set of a service ID and a data ID. The service ID is an identifier of a service that performs data transfer. The data ID is an identifier of data in the service.

FIG. 14 is a diagram illustrating an example of the directory. A copy-data retention ES list indicating an ES identifier of an ES that retains copy data of data indicated by the data ID is stored in the directory 313 in association with the set of the service ID and the data ID.

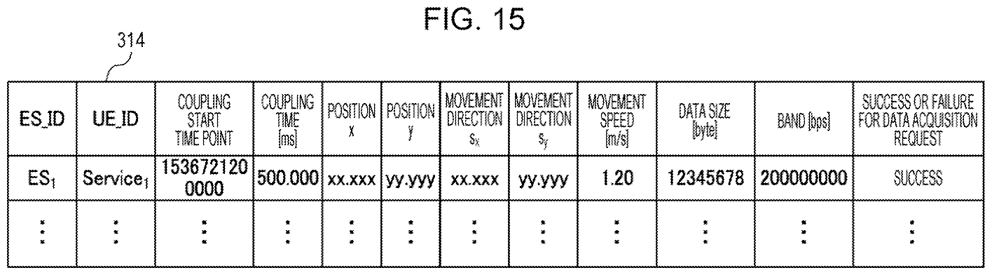

FIG. 15 is a diagram illustrating an example of the coupling tendency log. A record of each data acquisition request transmitted to any ES by the UE 200 or 200a is registered in the coupling tendency log 314. An ES identifier (ES_ID), a UE identifier (UE_ID), a coupling start time point, a coupling time, a position x, a position y, a movement direction sₓ, a movement direction s_{y}, a movement speed, a data size, a band, and a data acquisition request status are set in each record. The ES identifier (ES_ID) is an ES identifier of an ES that receives a data acquisition request. The UE identifier (UE_ID) is a UE identifier of a UE that transmits the data acquisition request. The coupling start time point is a time point at which the UE is coupled to the ES in order to acquire data. The coupling time is a time of communication coupling between the UE and the ES for data acquisition. The position x is a longitude of the position of the UE in coupling. The position y is a latitude of the position of the UE in coupling. The movement direction sₓ is a component of a vector indicating the movement direction of the UE in coupling in a longitude direction (east-west direction). The movement direction s_{y} is a component of the vector indicating the movement direction of the UE in coupling in a latitude direction (north-south direction). The movement direction of the UE is represented by a vector (sₓ, s_{y}). The length of the vector is “1” (sₓ²+s_{y}²=1). The movement speed is a movement speed (m/s) of the UE in coupling. The data size is a data volume of data to be acquired by the UE. The band is a communication speed between the UE and ES. The data acquisition request status is information indicating whether or not acquisition of copy data from the ES that has received the data acquisition request succeeds and ends in response to the data acquisition request.

FIG. 15 illustrates the example of the coupling tendency log 314 stored in the center server 300. However, data having the same type as the coupling tendency log 314 is set in the coupling tendency log 113 stored in the ES 100. Only a record corresponding to the data acquisition request received by the ES 100 is included in the coupling tendency log 113.

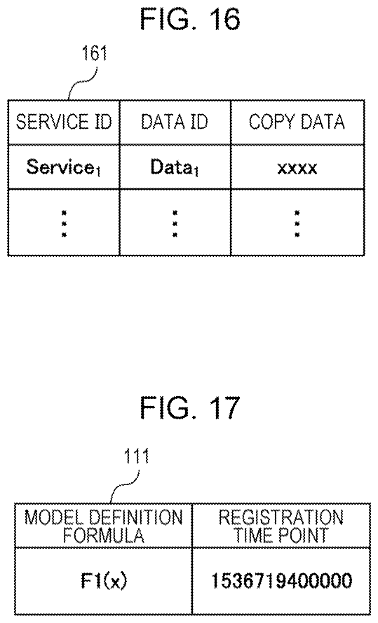

FIG. 16 is a diagram illustrating an example of copy data. Copy data is stored in the copy data group 161 retained by the ES 100b in association with a set of the service ID and the data ID.

FIG. 17 is a diagram illustrating an example of the determination model. A model definition formula and a registration time point are included in the determination model 111, The model definition formula is a formula of defining the communication available range of the AP 31 coupled to the ES 100. The registration time point is date and time when the ES 100 acquires the determination model and stores the determination model in the storage unit 110.

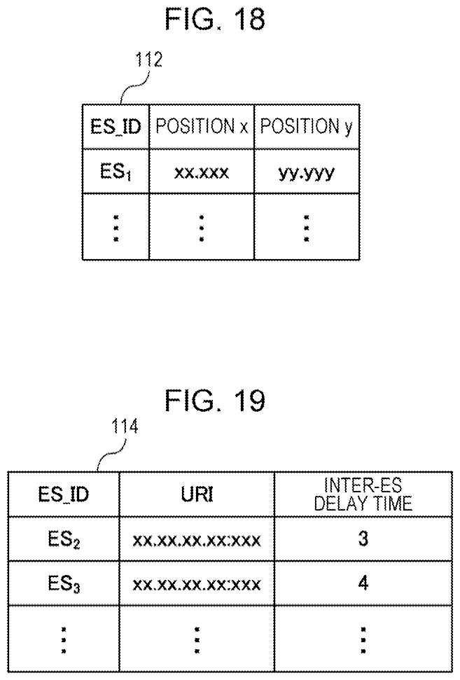

FIG. 18 is a diagram illustrating an example of the ES position information. The position x and the position y are set in the ES position information 112 in association with the ES identifier (ES_ID). The position x is a longitude of the position of the corresponding ES. The position y is a latitude of the position of the corresponding ES. In the second embodiment, it is assumed that the position of each ES is the same as the position of the AP coupled to the corresponding ES.

FIG. 19 is a diagram illustrating an example of the adjacent ES information. A Uniform Resource Identifier (URI) and the inter-ES delay time are set in the adjacent ES information 114 in association with the ES identifier (ES_ID), The URI is information indicating the position of a region in which the copy data group is stored in another ES enabled to communicate with the ES 100. The inter-ES delay time is the time required for acquiring data having a unit data volume from another ES enabled to communicate with the ES 100.

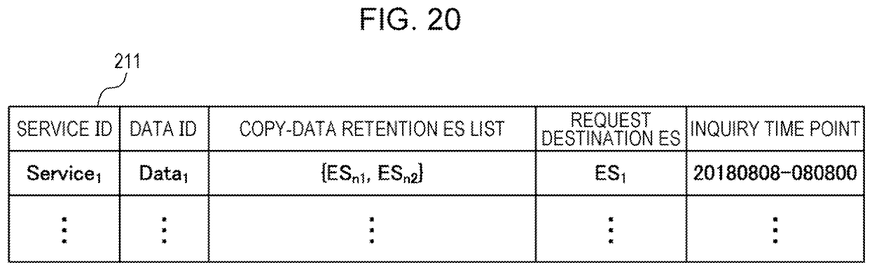

FIG. 20 is a diagram illustrating an example of the directory cache. A copy-data retention ES list, a request destination ES, and an inquiry time point are set in the directory cache 211 in association with a set of the service ID and the data ID. The copy-data retention ES list is a list of ESs that retain copy data of data corresponding to the set of the service ID and the data ID. The request destination ES is an ES identifier of an ES as a transmission destination when a data acquisition request of data corresponding to the set of the service ID and the data ID has been previously transmitted. The inquiry time point is date and time when the copy-data retention ES list is acquired.

The ES 100 or 100a transmits the copy-data retention ES list having a proper data volume to the UE 200 or 200a by using the above-described kinds of information. The data volume (cache size) of the copy-data retention ES list depends on whether or not the data acquisition request transmitted by the UE 200 or 200a succeeds. The determination model 111 is used for determining whether or not the data acquisition request succeeds.

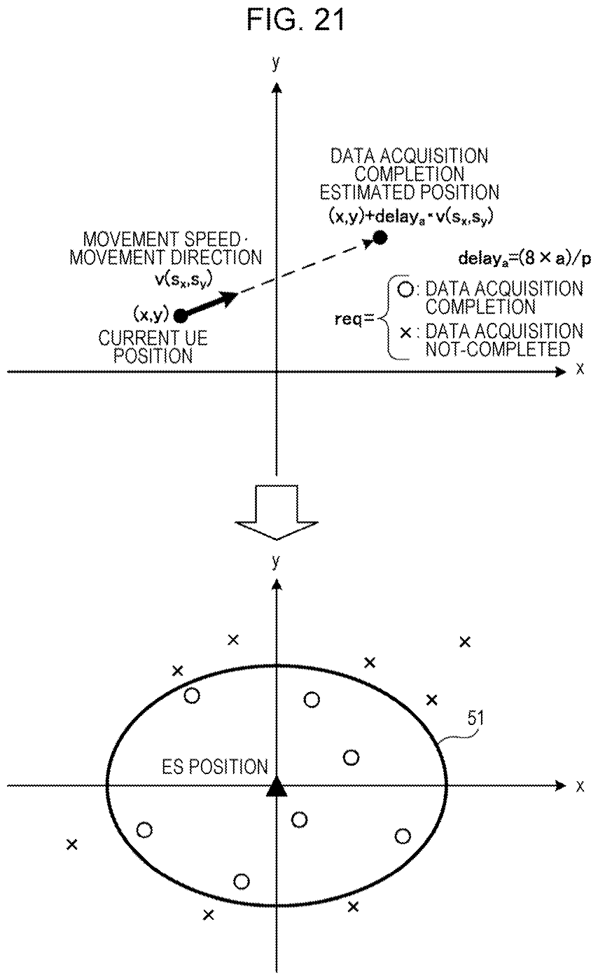

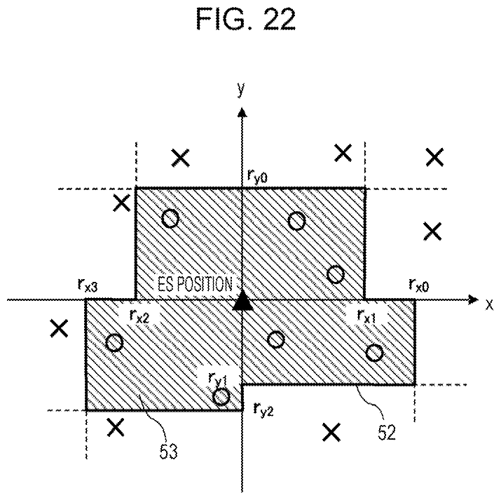

A method of generating the determination model 111 by the determination model generation unit 340 will be described below with reference to FIGS. 21 to 23.

FIG. 21 is a diagram illustrating a generation example of the determination model. In a case where the determination model generation unit generates a determination model 111 of the ES 100, for example, the determination model generation unit 340 extracts a record in which an ES identifier (ES₁) of the ES 100 is set, from the coupling tendency log 314. The determination model generation unit 340 calculates a data acquisition completion estimated position allowed to be predicted from information indicated in the log, for each extracted record.

For example, it is assumed that the position of the UE is (x, y), the movement speed is v (m/s), the movement direction is (sᵣ, s_{y}), the data size is a (byte), and a communication band with an ES as an acquisition source of copy data is p (bps). In this case, the data acquisition completion estimated position is represented by the following expression.

Data acquisition completion estimated position=(x,y)+delayₐ·v(sₓ,s_{y}) (1)

The delayₐ indicates a time required to acquire data and is represented by the following expression.

delayₐ=(8×a)/p (2)

The determination model generation unit 340 performs such calculation for each record corresponding to the data acquisition request received by the ES 100. The determination model generation unit 340 associates information of the data acquisition request status (req) indicated in the record, with the data acquisition completion estimated position obtained for each record. In the lower part in FIG. 21, in a case where the data acquisition request succeeds (data acquisition completed), a circle is set at the data acquisition completion estimated position in a coordinate system with the origin at the position (indicated by a triangle in FIG. 21) of the ES 100. In a case where the data acquisition request fails (data acquisition not completed), a cross mark is set at the data acquisition completion estimated position in the coordinate system. In the coordinate system, a horizontal axis x indicates a distance between the position of the ES 100 and the data acquisition completion estimated position in the east-west direction, and a vertical axis y indicates a distance between the position of the ES 100 and the data acquisition completion estimated position in the north-south direction.

As illustrated in FIG. 21, in many cases, as the data acquisition completion estimated position becomes closer to the position of the ES 100, a possibility that the data acquisition request succeeds increases. Even though the data acquisition completion estimated position is close to the position of the ES, data acquisition may not be completed by an installation environment of the ES 100, for example, a building is provided around the ES 100. Thus, a boundary line 51 that distinguishes the data acquisition completion estimated position when data acquisition is completed from the data acquisition completion estimated position when data acquisition is not completed is not a simple circle.

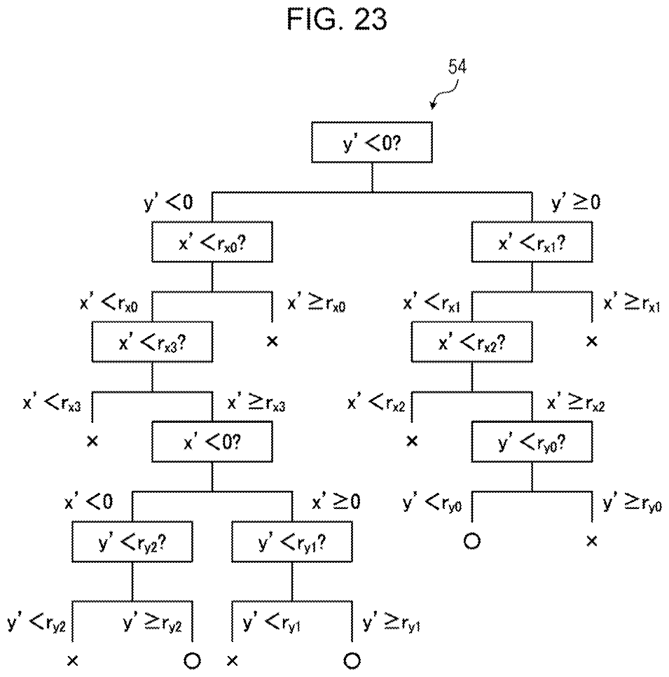

The determination model generation unit 340 obtains an expression of defining the boundary line 51 with a decision tree, a machine learning method, and the like. For example, a method such as a support vector machine is considered as the machine learning method. An example of generating the determination model 111 with the decision tree will be described below with reference to FIGS. 22 and 23.

FIG. 22 is a diagram illustrating a definition example of the boundary line. A boundary line 52 illustrated in FIG. 22 has a polygonal shape having a straight line parallel to an x-axis and a y-axis, as a side. The determination model generation unit 340 divides, for example a planar coordinate system with the origin at the position of the ES 100, into four quadrants in order to create the boundary line 52.

The determination model generation unit 340 generates a straight line parallel to each of the x-axis and the y-axis for each quadrant. This straight line distinguishes the data acquisition completion estimated position (circle in FIG. 22) when data acquisition is completed, from the data acquisition completion estimated position (cross mark in FIG. 22) when data acquisition is not completed. In the example in FIG. 22, regarding a first quadrant, a straight line which passes through a point (rₓ₁, 0) and is parallel to the y-axis and a straight line which passes through a point (0, r_{y0}) and is parallel to the x-axis are generated. Regarding a second quadrant, a straight line which passes through a point (rₓ₂, 0) and is parallel to the y-axis and a straight line which passes through a point (0, r_{y0}) and is parallel to the x-axis are generated. Regarding a third quadrant, a straight line which passes through a point (rₓ₃, 0) and is parallel to the y-axis and a straight line which passes through a point (0, r_{y2}) and is parallel to the x-axis are generated. Regarding a fourth quadrant, a straight line which passes through a point (rₓ₀, 0) and is parallel to the y-axis and a straight line which passes through a point (0, r_{y1}) and is parallel to the x-axis are generated.

The determination model generation unit 340 sets the boundary line 52 between a region 53 on the origin side from the generated straight line and a region on the outside thereof, as a boundary line that distinguishes the data acquisition completion estimated position when data acquisition is completed, from the data acquisition completion estimated position when data acquisition is not completed. The determination model generation unit 340 generates a decision tree based on such a boundary line 52.

FIG. 23 is a diagram illustrating an example of the decision tree. When a request status of a data acquisition request is predicted, a data acquisition completion estimated position obtained from the movement tendency of the data acquisition request or the data size is set to (x′, V). At this time, the determination model generation unit 340 generates a decision tree 54 for determining whether the data acquisition request succeeds or fails as illustrated in FIG. 23, based on the boundary line 52 illustrated in FIG. 22.

In the decision tree 54, firstly, it is determined whether or not “y′<0” is satisfied.

In a case where “y′<0” is satisfied, it is determined whether or not “x′<rₓ₀” is satisfied. In a case where “x′<rₓ₀” is not satisfied, the request is determined to fail. In a case where “x′<rₓ₀” is satisfied, it is determined whether or not “x′<rₓ₃” is satisfied. In a case where “x′<rₓ₃” is satisfied, the request is determined to fail. In a case where “x′<rₓ₃” is not satisfied, it is determined whether or not “x′<0” is satisfied. In a case where “x′<0” is satisfied, it is determined whether or not “y′<r_{y2}” is satisfied. In a case where “y′<r_{y2}” is satisfied, the request is determined to fail. In a case where “y′<r_{y2}” is not satisfied, the request is determined to fail. In a case where “x′<0” is not satisfied, it is determined whether or not “y′<r_{y1}” is satisfied. In a case where “y′<r_{y1}” is satisfied, the request is determined to fail. In a case where “y′<r_{y1}” is not satisfied, the request is determined to succeed.

In a case where “y′<0” is not satisfied, it is determined whether or not “x′<rₓ₁” is satisfied. In a case where “x′<rₓ₁” is not satisfied, the request is determined to fail. In a case where “x′<rₓ” is satisfied, it is determined whether or not “x′<rₓ₂” is satisfied. In a case where “x′<rₓ₂” is satisfied, the request is determined to fail. In a case where “x′<rₓ₂” is not satisfied, it is determined whether or not “y′<r_{y0}” is satisfied. In a case where “y′<r_{y0}” is satisfied, the request is determined to succeed. In a case where “y∝<r_{y0}” is not satisfied, the request is determined to fail.

As described above, if the decision tree 54 is used, it may be determined whether or not the data acquisition completion estimated position is in a region 53 on the inner side of the boundary line 52 illustrated in FIG. 22. If the data acquisition completion estimated position is in the region 53, the request is determined to succeed. If being out of the region 53, the request is determined to fail.

In the example in FIG. 22, in order to cause the generation method of the decision tree 54 to be easy to understand, the shape of the boundary line 52 is set to be simple, but a boundary line having a more complicated shape may also be generated. If a support vector machine or the like is used, the boundary line may be defined by a curve.

As described above, in the determination model 111, a method of predicting the request status of the data acquisition request and determining whether or not the request succeeds is defined. The determination model generation unit 340 transmits the determination model 111 generated based on the coupling tendency log of the ES 100 to the ES 100. Such generation of the determination model is performed for all ESs that receives the data acquisition request. Thus, each of the ESs 100 and 100a may acquire a separate determination model proper for the corresponding ES.

If the ES 100 receives a data acquisition request, the request status prediction unit 150 of the ES 100 that acquires the determination model 111 predicts whether or not the data acquisition request succeeds, based on the determination model 111. The request processing unit 140 determines the data volume (cache size) of a copy-data retention ES list to be transmitted to the UE 200, based on a prediction result of the request status.

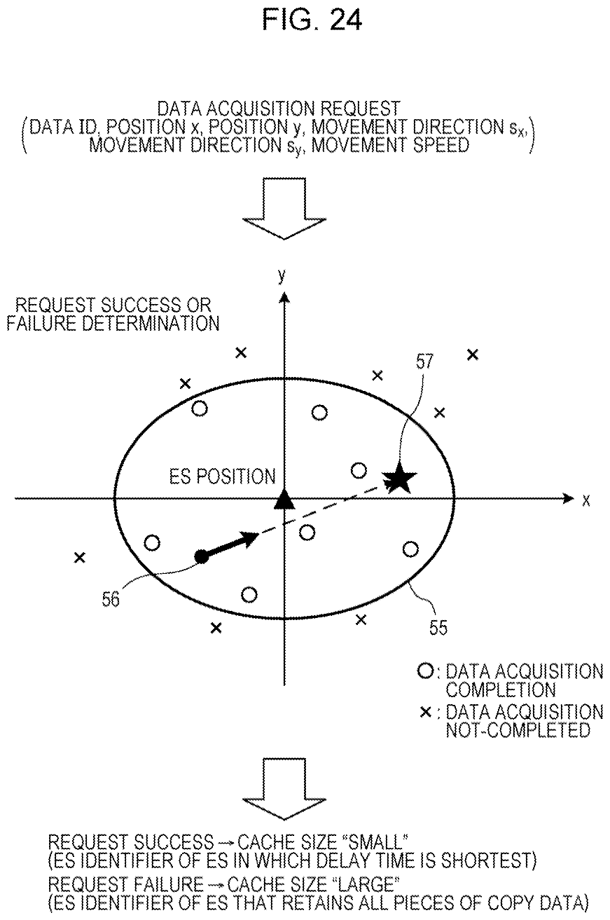

FIG. 24 is a diagram illustrating an example of cache size determination. For example, information such as the data ID, the position x, the position y, the movement direction sₓ, the movement direction s_{y}, and the movement speed is included in the data acquisition request transmitted from the UE 200. The data size may be acquired from the center server 300 along with the copy-data retention ES list, for example.

The request status prediction unit 150 recognizes a UE current position 56 from the information included in the data acquisition request and the data size and further calculates a data acquisition completion estimated position 57. The request status prediction unit 150 determines whether or not the data acquisition completion estimated position 57 is in a region on the inner side of a boundary line 55, by using the determination model 111. If the data acquisition completion estimated position 57 is in the region on the inner side of the boundary line 55, the request status prediction unit 150 determines that the data acquisition request succeeds (data acquisition is completed). If the data acquisition completion estimated position 57 is not in the region on the inner side of the boundary line 55, the request status prediction unit 150 determines that the data acquisition request fails (data acquisition is not completed). The request status prediction unit 150 notifies the request processing unit 140 of a determination result.

In a case where the request is predicted to succeed, the request processing unit 140 reduces the cache size to the minimum. The request processing unit 140 includes only an ES identifier of an ES having the smallest delay time, in the copy-data retention ES list retained by the UE 200. In a case where the request is predicted to fail, the request processing unit 140 increases the cache size. The request processing unit 140 includes ES identifiers of all ESs that retain copy data, in the copy-data retention ES list retained by the UE 200.

In this manner, it is possible to reduce the data volume of the copy-data retention ES list retained by the UE 200. If such reduction of the data volume of the copy-data retention ES list is performed for all pieces of data acquired by the UE 200, it is possible to largely reduce the data volume of the directory cache 211 in the UE 200.

Next, a procedure of a copy data providing process for the UE 200 by the ES 100 will be described with reference to a flowchart.

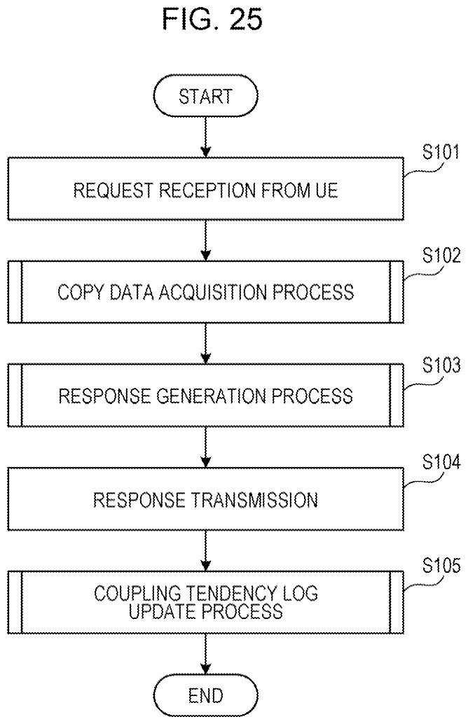

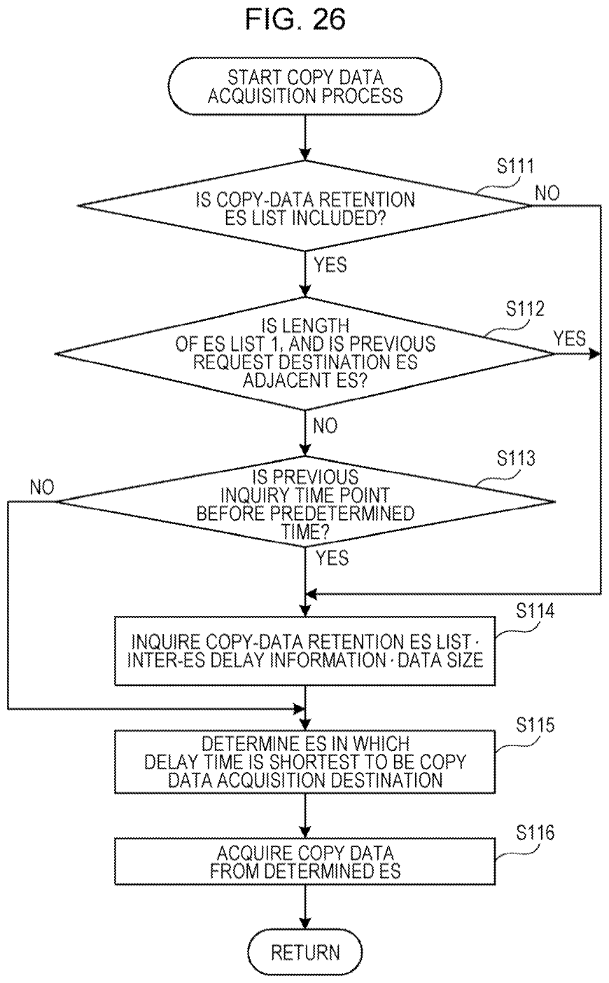

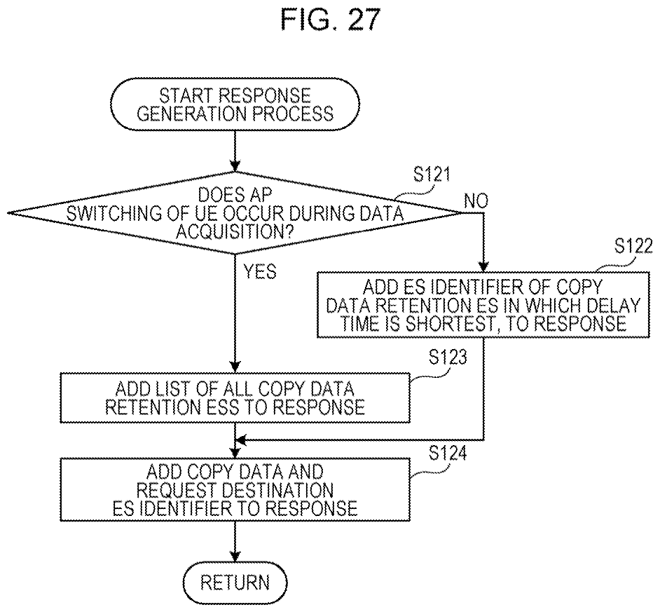

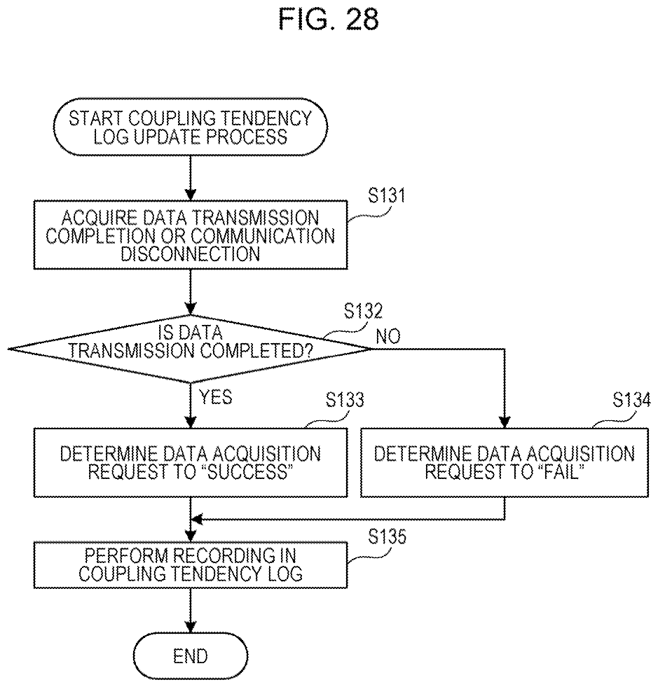

FIG. 25 is a flowchart illustrating an example of the procedure of the copy data providing process. The processing illustrated in FIG. 25 will be described below with step numbers.

[Step S101] The request processing unit 140 receives a data acquisition request from the UE 200.

[Step S102] The request processing unit 140 determines an ES as an acquisition destination of copy data in cooperation with the data position determination unit 130, and acquires the copy data from the determined ES. Details of the copy data acquisition process will be described later (see FIG. 26).

[Step S103] The request processing unit 140 performs a response generation process in response to a result obtained by the request status prediction unit 150 predicting the data acquisition request status. Details of the response generation process will be described later (see FIG. 27).

[Step S104] The request processing unit 140 transmits a response to the UE 200. For example, the request processing unit 140 transmits information such as the copy-data retention ES list except for copy data, to the destination as a response and then transmits the copy data. Thus, even in a case where acquisition of copy data by the UE 200 fails, it is possible to reliably transfer information such as the copy-data retention ES list except for the copy data, to the UE 200.

[Step S105] The coupling tendency log management unit 120 updates the coupling tendency log 113 based on a result of processing in response to the data acquisition request. Details of a procedure of a coupling tendency log update process will be described later (see FIG. 28).

Copy data is provided for the UE 200 with such a procedure. Next, the copy data acquisition process (Step S102), the response generation process (Step S103), and the coupling tendency log update process (Step S105) will be described in detail.

FIG. 26 is a flowchart illustrating an example of a procedure of the copy data acquisition process. The processing illustrated in FIG. 26 will be described below with step numbers.

[Step S111] The request processing unit 140 determines whether or not the copy-data retention ES list is included in a data acquisition request received from the UE 200. In a case where the copy-data retention ES list is included, the request processing unit 140 causes the process to proceed to Step S112. In a case where the copy-data retention ES list is not included, the request processing unit 140 causes the process to proceed to Step S114.

[Step S112] The request processing unit 140 determines whether or not to satisfy conditions that the length of the copy-data retention ES list (number of registered ES identifiers) is “1”, and the previous request destination ES is an adjacent ES. In a case where the conditions are satisfied, the request processing unit 140 causes the process to proceed to Step S114. In a case where the conditions are not satisfied, the request processing unit 140 causes the process to proceed to Step S113.

[Step S113] The request processing unit 140 determines whether or not the previous inquiry time point is before a predetermined time or longer from the current time point. If the previous inquiry time point is a time point before the predetermined time or longer, the request processing unit 140 causes the process to proceed to Step S114. If the previous inquiry time point is not a time point before the predetermined time or longer, the request processing unit 140 causes the process to proceed to Step S115.

[Step S114] The request processing unit 140 requests determination of an ES as an acquisition destination of copy data, from the data position determination unit 130. If the request processing unit requests the determination, the data position determination unit 130 inquires, for example, the copy-data retention ES list, the inter-ES delay information, and the data size from the center server 300. A data ID of data as an acquisition target is included in the inquiry. The center server 300 transmits the copy-data retention ES list, the inter-ES delay information, and the data size corresponding to the designated data ID in response to the inquiry.

[Step S115] The data position determination unit 130 determines an ES having the shortest delay time. For example, the data position determination unit 130 refers to the inter-ES delay information to acquire an inter-ES delay time between an ES indicated in the copy-data retention ES list acquired from the UE 200 or the center server 300 and the ES 100. The data position determination unit 130 compares the inter-ES delay time of each ES and determine an ES having the shortest inter-ES delay time to be the acquisition destination of the copy data. The data position determination unit 130 notifies the request processing unit 140 of an ES identifier indicating an ES as the acquisition destination of the copy data.

[Step S116] The request processing unit 140 acquires the copy data from the ES determined as the acquisition destination of the copy data.

With such a process, in a case where the copy-data retention ES list is transmitted from the UE 200, it is possible to complete acquisition without an inquiry from the center server 300, and thus the process is efficiently performed. Even in a case where the copy-data retention ES list is transmitted from the UE 200, the transmitted copy-data retention ES list may be old by a predetermined time or longer, or the UE 200 may largely move between ESs contrary to the previous determination of the request status (result of determination to succeed). In such a case, an inquiry from the center server 300 is performed. Thus, in a case where a result obtained by predicting the request status when the UE 200 transmits the previous data acquisition request is erroneous, the copy-data retention ES list is acquired again.

Next, the response generation process will be described in detail.

FIG. 27 is a flowchart illustrating an example of a procedure of the response generation process. The processing illustrated in FIG. 27 will be described below with step numbers.

[Step S121] The request processing unit 140 requests determination of whether or not the data acquisition request succeeds, from the request status prediction unit 150, and determines whether or not the AP is switched in the middle of the UE 200 acquiring data. For example, the request status prediction unit 150 determines whether or not the data acquisition completion estimated position is within the communication available range of the AP 31 coupled to the ES 100, based on the determination model 111 in response to the request of the request processing unit 140. If the data acquisition completion estimated position is within the communication available range, the request status prediction unit 150 determines that the data acquisition request succeeds. If the data acquisition completion estimated position is not within the communication available range, the request status prediction unit 150 determines that the data acquisition request fails. In a case where the data acquisition request fails, the request processing unit 140 determines that the AP is switched.

In a case where it is determined that the AP is switched, the request processing unit 140 causes the process to proceed to Step S123. In a case where it is determined that the AP is not switched, the request processing unit 140 causes the process to proceed to Step S122.

[Step S122] The request processing unit 140 includes an ES identifier of an ES in which a delay time between the ES and the ES 100 is the shortest, and copy data is retained, in the copy-data retention ES list acquired from the center server 300, in a response as a copy-data retention ES list. Then, the request processing unit 140 causes the process to proceed to Step S124.

[Step S123] The request processing unit 140 adds a copy-data retention ES list including all ES identifiers indicated in the copy-data retention ES list acquired from the center server 300, to the response.

[Step S124] The request processing unit 140 adds the copy data and an ES identifier of a request destination ES (ES 100) to the response.

As described above, in a case where the data acquisition request is determined to succeed in request status determination, the copy-data retention ES list including only an ES identifier of one ES is included in the response. As a result, the UE 200 may retain the copy-data retention ES list having a small data volume in the directory cache 211, and the data volume of the cache is reduced.

Next, the coupling tendency log update process will be described in detail.

FIG. 28 is a flowchart illustrating an example of a procedure of the coupling tendency log update process. The processing illustrated in FIG. 28 will be described below with step numbers.

[Step S131] The coupling tendency log management unit 120 acquires a time (coupling time) from a transmission start of the response to the UE 200 until data transmission is completed, or the communication is disconnected.

[Step S132] The coupling tendency log management unit 120 determines whether data transmission is completed or not completed. In a case where data transmission is completed, the coupling tendency log management unit 120 causes the process to proceed to Step S133. In a case where data transmission is not completed, the coupling tendency log management unit 120 causes the process to proceed to Step S134.

[Step S133] The coupling tendency log management unit 120 determines a status of the data acquisition request to be “success”. Then, the coupling tendency log management unit 120 causes the process to proceed to Step S135.

[Step S134] The coupling tendency log management unit 120 determines a status of the data acquisition request to be “failure”.

[Step S135] The coupling tendency log management unit 120 records a new record in the coupling tendency log 113, The ES identifier (ES_ID) of the ES 100, the UE identifier (UE_ID) of the UE 200, the coupling start time point, the coupling time, the position x, the position y, the movement direction sₓ, the movement direction s_{y}, the movement speed, the data size, the band, and the data acquisition request status are included in the record to be added.

In this manner, the ES 100 adds a new record to the coupling tendency log 113 for each data acquisition request. The coupling tendency log management unit 120 regularly transmits the coupling tendency log 113 retained by the ES 100 to the center server 300, for example.

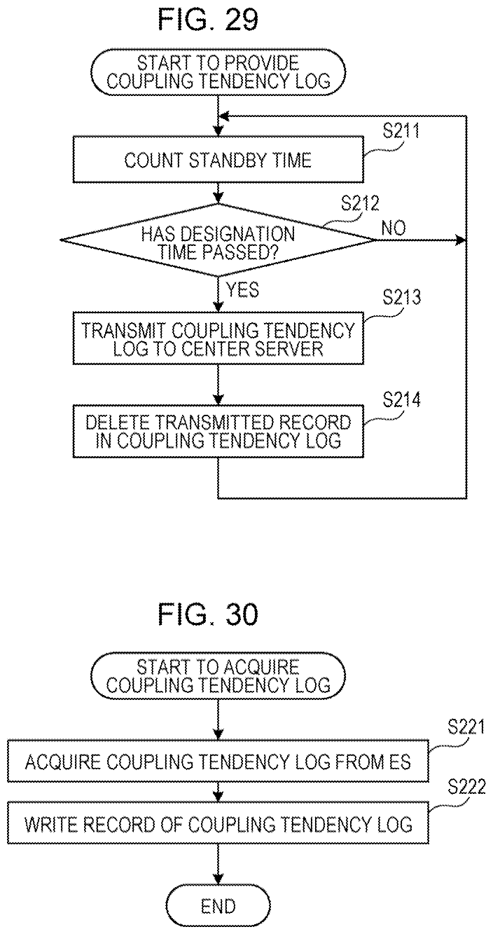

FIG. 29 is a flowchart illustrating an example of a procedure of the coupling tendency log providing process by the ES. The processing illustrated in FIG. 29 will be described below with step numbers.

[Step S211] The coupling tendency log management unit 120 counts a standby time.

[Step S212] The coupling tendency log management unit 120 determines whether or not the standby time has passed a predetermined designation time. In a case where the designation time has passed, the coupling tendency log management unit 120 resets the count of the standby time and causes the process to proceed to Step S213. If the designation time has not passed, the coupling tendency log management unit 120 causes the process to proceed to Step S211 and continues to count the standby time.

[Step S213] The coupling tendency log management unit 120 transmits the coupling tendency log 113 to the center server 300.

[Step S214] The coupling tendency log management unit 120 deletes the transmitted record from the coupling tendency log 113. Then, the coupling tendency log management unit 120 causes the process to proceed to Step S211.

In this manner, the ES 100 regularly transmits the contents of the coupling tendency log 113 to the center server 300. In the center server 300, the contents of the coupling tendency log 113 transmitted from the ES 100 is accumulated in the coupling tendency log 113.

FIG. 30 is a flowchart illustrating an example of a procedure of the coupling tendency log acquisition process by the center server. The processing illustrated in FIG. 30 will be described below with step numbers.

[Step S221] The determination model generation unit 340 in the center server 300 acquires the coupling tendency log 113 transmitted from the ES 100.

[Step S222] The determination model generation unit 340 writes a record included in the received coupling tendency log 113 in the coupling tendency log 314 in the storage unit 310.

The determination model generation unit 340 creates the determination model based on the coupling tendency log 113 acquired from the ES 100.

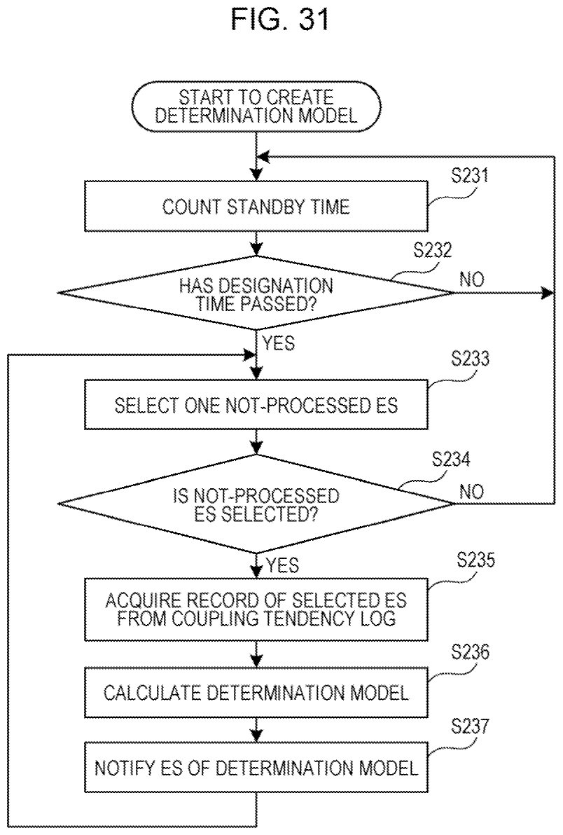

FIG. 31 is a flowchart illustrating an example of a procedure of the determination model creation process. The processing illustrated in FIG. 31 will be described below with step numbers.

[Step S231] The determination model generation unit 340 counts the standby time.

[Step S232] The determination model generation unit 340 determines whether or not the standby time has passed a predetermined designation time. In a case where the designation time has passed, the determination model generation unit 340 resets the count of the standby time and causes the process to proceed to Step S233. If the designation time has not passed, the determination model generation unit 340 causes the process to proceed to Step S231 and continues to count the standby time.

[Step S233] The determination model generation unit 340 selects one not-processed ES among ESs having an ES identifier (ES_ID) registered in the coupling tendency log 314.

[Step S234] The determination model generation unit 340 determines whether or not selection of the not-processed ES is possible. For example, if the not-processed ES remains, the determination model generation unit 340 is capable of selecting the not-processed ES. However, if all ESs are already processed, it is not possible that the determination model generation unit 340 selects the not-processed ES. In a case where selection of the not-processed ES is possible, the determination model generation unit 340 causes the process to proceed to Step S235. In a case where all the ESs are already processed, and it is not possible to select the not-processed ES, the determination model generation unit 340 causes the process to proceed to Step S231.

[Step S235] The determination model generation unit 340 acquires a record of the ES selected from the coupling tendency log 314.

[Step S236] The determination model generation unit 340 calculates a determination model using a method such as the decision tree and the machine learning method.

[Step S237] The determination model generation unit 340 notifies the selected ES of the generated determination model. Then, the determination model generation unit 340 causes the process to proceed to Step S233.

In this manner, the determination model is generated for each ES. Since the determination model is generated for each ES, accuracy of determining whether or not the data acquisition request succeeds is improved. An installation environment differs for each ES, and it is not possible to define the communication available range of the AP coupled to the ES only by the distance from the AP. The center server 300 creates the determination model for each ES based on the coupling tendency log collected from the ESs, and thus may calculate the proper communication available range corresponding to the installation environment of the ES and generate an accurate determination model based on the calculated communication available range.

Next, an acquisition process of copy data in a case where the UE 200 does not have the copy-data retention ES list of data to be acquired and attempts to acquire the data while moving at a high speed will be described with reference to the sequence diagram.

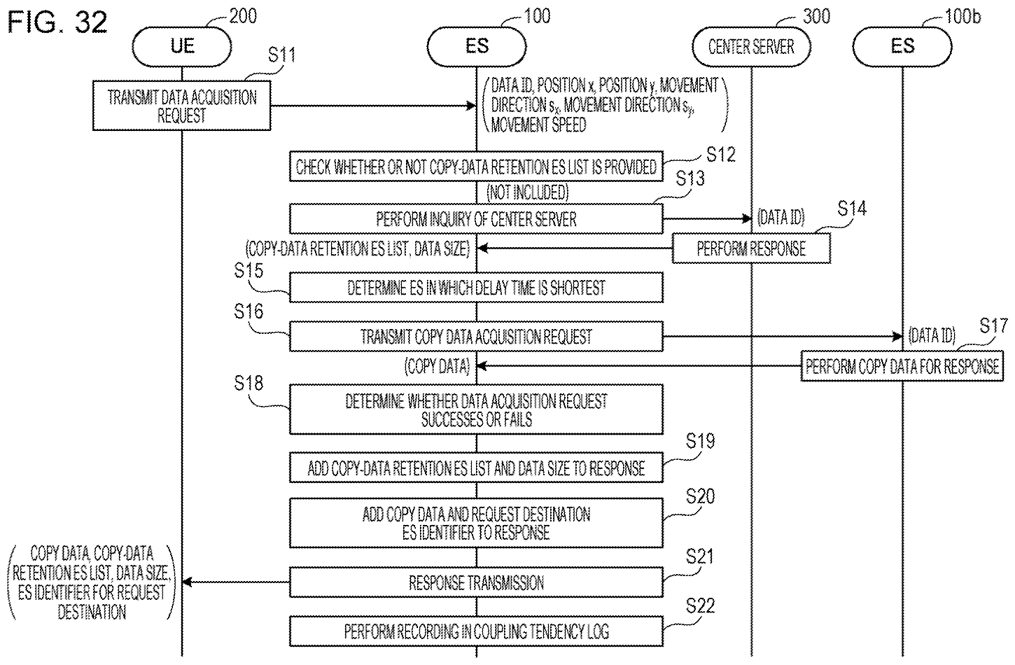

FIG. 32 is a sequence diagram illustrating a first example of the acquisition process of copy data by the UE.

Firstly, the UE 200 transmits a data acquisition request to the ES 100 (Step S11). For example, the data ID, the position x, the position y, the movement direction sₓ, the movement direction s_{y}, and the movement speed are included in the data acquisition request. The ES 100 analyzes the data acquisition request and checks whether or not the copy-data retention ES list is provided (Step S12). In the example in FIG. 32, the copy-data retention ES list is not included. The ES 100 transmits an inquiry of the position of a copy to the center server 300 (Step S13). For example, a data ID of data of which acquisition is requested by the UE 200 is included in the inquiry of the position of the copy. The center server 300 transmits a copy-data retention ES list and a data size corresponding to the data ID to the ES 100 in response to the inquiry of the position of the copy (Step S14).

The ES 100 determines an ES having the shortest delay time among ESs that retain copy data (Step S15). In the example in FIG. 32, it is assumed that the ES having the shortest delay time is the ES 100b. The ES 100 transmits a copy data acquisition request to the determined ES 100b (Step S16). A data ID of data as an acquisition target is included in the copy data acquisition request. The ES 100b that receives the copy data acquisition request transmits copy data corresponding to the designated data ID to the ES 100 as a response (Step S17).

The ES 100 determines whether or not the data acquisition request succeeds (whether or not the AP coupled to the UE 200 is switched), based on the determination model 111 (Step S18). The ES 100 determines an ES identifier included in the copy-data retention ES list based on the result obtained by determination of whether or not the data acquisition request succeeds, and adds a copy-data retention ES list including the determined ES identifier and a data size to a response (Step S19). The ES 100 adds copy data and an ES identifier of a request destination ES (ES 100) to the response (Step S20). The ES 100 transmits the response to the UE 200 (Step S21). Then, the ES 100 records the contents of the process in response to the data acquisition request, in the coupling tendency log 113 (Step S22).

Next, the acquisition process of copy data in a case where the UE 200 has the copy-data retention ES list of data to be acquired and attempts to acquire the data while moving at a high speed will be described with reference to the sequence diagram.

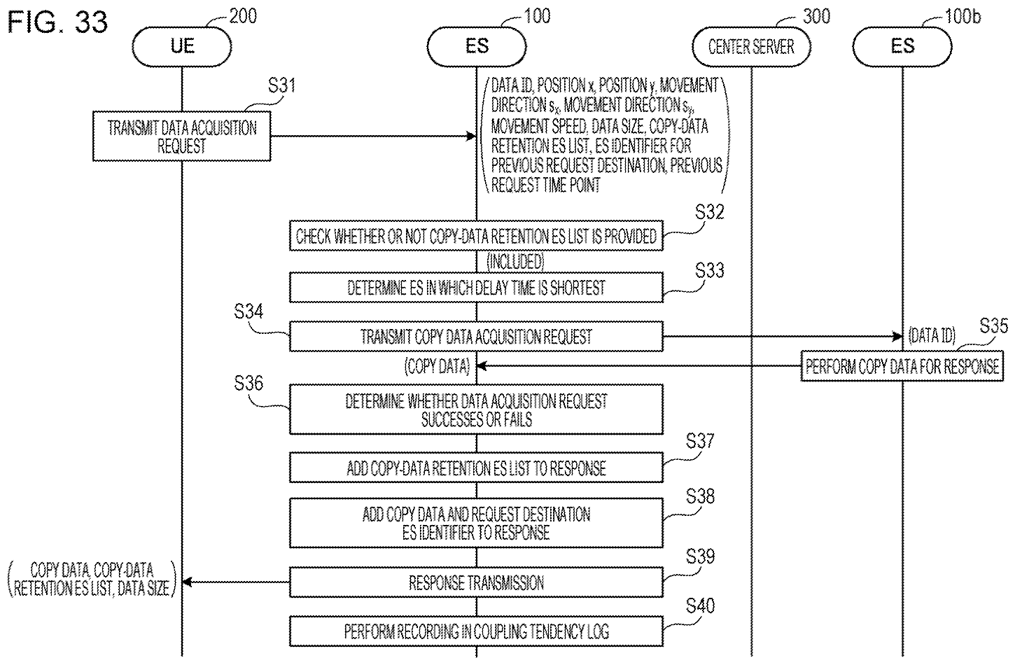

FIG. 33 is a sequence diagram illustrating a second example of the acquisition process of the copy data by the UE.

Firstly, the UE 200 transmits a data acquisition request to the ES 100 (Step S31). For example, the data ID, the position x, the position y, the movement direction sₓ, the movement direction s_{y}, the movement speed, the data size, the copy-data retention ES list, a previous request destination ES identifier, and a previous request time point are included in the data acquisition request. The ES 100 analyzes the data acquisition request and checks whether or not the copy-data retention ES list is provided (Step S32). In the example in FIG. 33, the copy-data retention ES list is included. The ES 100 determines an ES having the shortest delay time among ESs indicated in the copy-data retention ES list included in the data acquisition request (Step S33). In the example in FIG. 33, it is assumed that the ES having the shortest delay time is the ES 100b The ES 100 transmits a copy data acquisition request to the determined ES 100b (Step S34). A data ID of data as an acquisition target is included in the copy data acquisition request. The ES 100b that receives the copy data acquisition request transmits copy data corresponding to the designated data ID to the ES 100 as a response (Step S35).

The ES 100 determines whether or not the data acquisition request succeeds (whether or not the AP coupled to the UE 200 is switched), based on the determination model 111 (Step S36). The ES 100 determines an ES identifier included in the copy-data retention ES list based on the result obtained by determination of whether or not the data acquisition request succeeds, and adds a copy-data retention ES list including the determined ES identifier and a data size to a response (Step S37). The ES 100 adds copy data and an ES identifier of a request destination ES (ES 100) to the response (Step S38). The ES 100 transmits the response to the UE 200 (Step S39). Then, the ES 100 records the contents of the process in response to the data acquisition request, in the coupling tendency log 113 (Step S40).

As described above, in the second embodiment, the ES 100 determines whether or not data acquisition is completed, from the movement tendency of the UE 200 and the data size of data to be acquired. The ES 100 determines an ES identifier to be included in the copy-data retention ES list disposed over the UE 200, based on the determination result. In a case where the UE 200 is capable of completing data acquisition in the communication available range of the AP 31 coupled to the ES 100, the ES 100 includes only an ES identifier of an ES having the shortest delay time, in the copy-data retention ES list. Thus, the size of the directory cache 211 is reduced.

In a case where it is determined that it is not possible for the UE 200 to complete data acquisition, the ES 100 includes ES identifiers of all ESs that retain copy data, in the copy-data retention ES list. In a case where the UE 200 moves between the ESs, the ES 100 transmits the copy-data retention ES list to an ES (for example, ES 100a) as a movement destination from the UE 200. Thus, it is possible to reduce an inquiry from the center server 300 and improve efficiency of the processing.

The reduced amount of the cache size according to the second embodiment will be considered below.

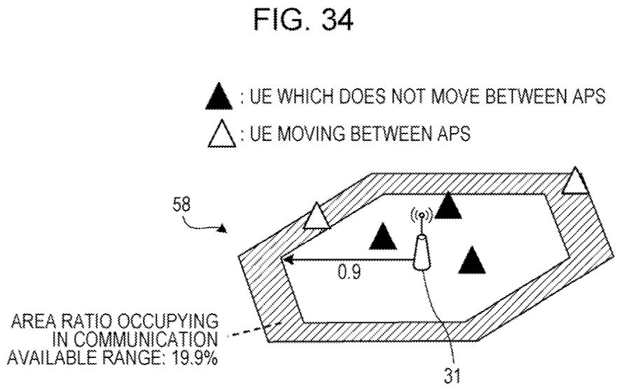

FIG. 34 is a diagram illustrating an example of a communication available range of one AP. For example, it is assumed that a communication available range 58 as illustrated in FIG. 34 may be defined with the determination model 111 for the AP 31 coupled to the ES 100. The number of UEs visiting the ES 100 in a predetermined time is set to 1000. The number of types of data as a transfer target by the center server 300 is set to 1000. It is assumed that the copy data is distributed to 10 ESs.

It is assumed that a UE at a position at which a distance from the AP 31 is smaller than 90% of a distance from the AP 31 to a boundary between the communication available range 58 and the outside does not move between APs. It is assumed that a UE in the communication available range 58 at a position at which the distance from the AP 31 is equal to or greater than 90% of the distance from the AP 31 to the boundary between the communication available range 58 and the outside moves between APs. An area of a region corresponding to 90% or greater of the distance from the AP 31 to the boundary between the communication available range 58 and the outside in the communication available range 58 is 19.9% with respect to the total area of the communication available range 58. If the UEs are uniformly distributed in the communication available range 58, 199% of all the UEs moves between the APs during data acquisition (determined that data acquisition is not completed). If the UE moves between the APs, it is possible to reduce the data volume of the copy-data retention ES list for UEs corresponding to 80.1% of all the UEs, by applying the second embodiment.

The data size of all copy-data retention ES lists included in the directory cache retained by each UE is represented by the following expression.

Data size of all copy-data retention ES lists=the number of pieces of data referred by the UE×the number of ES identifiers in the copy-data retention ES list (3)

The number of pieces of data referred by the UE is set to be uniform for all UEs. In a case where ES identifiers of all ESs that retain copy data are normally included in the copy-data retention ES list without applying the second embodiment, an average of the number of ES identifiers in the copy-data retention ES list per one UE is “10”.

On the contrary, in a case where the second embodiment is applied, and thus reduction of the data volume of the copy-data retention ES list is achieved, the average of the number of ES identifiers in the copy-data retention ES list per one UE is represented by the following expression.

0.199×10+0.801×1=2.79 (4)

Since the second embodiment is applied, it is possible to reduce the data size of all copy-data retention ES lists in the directory cache by 27.9% in average in comparison to a case of not applying the second embodiment.

### Third Embodiment

Next, a third embodiment will be described. In the third embodiment, even in a case where the UE moves between APs during data acquisition, the number of ES identifiers in the copy-data retention ES list retained by the UE is reduced depending on the movement direction.

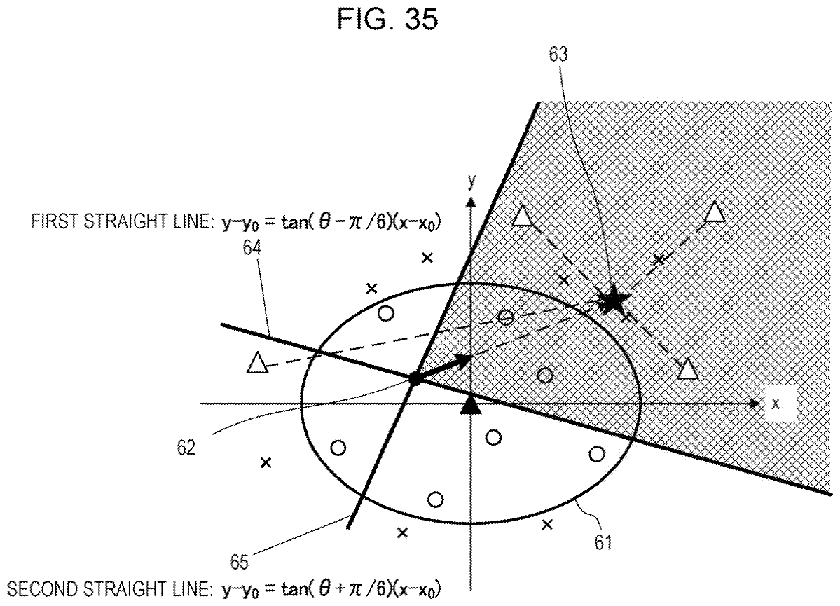

FIG. 35 is a diagram illustrating a determination example of the size of the copy-data retention ES list retained by the UE, depending on the movement direction of the UE. For example, the ES 100 that receives a data acquisition request from the UE 200 determines whether or not the data acquisition request succeeds, by using the determination model 111. Information such as “the movement speed”, “the movement direction”, and “the position” of which the notification is received from the UE 200, and “the data size” obtained as a result of the inquiry from the center server 300, and the position of the ES 100 that receives the data acquisition request are input to the determination model 111. The ES 100 predicts whether or not the data acquisition request succeeds, based on the information. The determination process of whether or not the data acquisition request succeeds is similar to that in the second embodiment. In the third embodiment, in the process of determining whether or not the data acquisition request succeeds, a data acquisition completion estimated position 63 is calculated based on information such as a UE current position 62. In the third embodiment, in a case where the data acquisition completion estimated position 63 is on the outside of a boundary line 61 of the communication available range of the AP 31 coupled to the ES 100, the ES 100 limits ESs to be registered in the copy-data retention ES list in accordance with the UE current position 62 and the movement direction.

For example, in a case where it is determined that data acquisition is completed, the ES 100 includes only an ES identifier of an ES as the acquisition source of copy data which is being currently acquired, in the copy-data retention ES list for the UE 200. In a case where it is determined that data acquisition is not completed, the ES 100 reduces the number of ES identifiers to be included in the copy-data retention ES list in accordance with the movement direction of the UE 200.

For example, the ES 100 selects an ES in the half region on the movement direction side among ESs that retain copy data, based on the position (x, y) of the UE 200, and includes the ES identifier of the selected ES in the copy-data retention ES list retained by the UE 200. For example, the ES 100 selects an ES in a region corresponding to 1/N (N is a real number more than 1) of all directions (angle π) on the movement direction side, based on the position (x, y) of the UE 200, and includes the ES identifier of the selected ES in the copy-data retention ES list retained by the UE 200. If N is 6, the number of ES identifiers included in the copy-data retention ES list is narrowed to ⅙ of the number of ESs that retain copy data around the ES 100.

Specifically, the ES 100 determines whether or not each of the ESs that retain copy data is selected as a registration target into the copy-data retention ES list, by the following method.

For example, the ES 100 sets an ES in a range (registration target range) of 30° (π/6) to right and left of the movement direction with respect to the current position (x₀, y₀) of the UE 200 and the data acquisition completion estimated position (x′, y′), to be a registration target into the copy-data retention ES list. The ES 100 obtains a first straight line 64 and a second straight line 65. The first straight line 64 passes through the UE current position 62 and is in a direction rotated clockwise by 30° from the movement direction of the UE 200. The second straight line 65 passes through the UE current position 62 and is in a direction rotated counterclockwise by 30° from the movement direction of the UE 200.

A slope of the movement direction is defined by the following expression.

$$tan ( θ ) = \frac{{y}^{′} - {y}_{0}}{{x}^{′} - {x}_{0}} \qquad ( 5 )$$

In this case, a slope of the first straight line 64 is represented by the following expression.

$$tan ( θ - π \text{/} 6 ) = \frac{tan ( θ ) - tan ( π \text{/} 6 )}{1 + tan ( θ ) tan ( π \text{/} 6 )} \qquad ( 6 )$$

Similarly, a slope of the second straight line 65 is represented by the following expression.

$$tan ( θ + π \text{/} 6 ) = \frac{tan ( θ ) + tan ( π \text{/} 6 )}{1 - tan ( θ ) tan ( π \text{/} 6 )} \qquad ( 7 )$$

The first straight line and the second straight line are represented by the following expressions, respectively.

First straight line: y−y₀=tan(θ−π/6)(x−x₀) (8)

Second straight line: y−y₀=tan(θ+π/6)(x−x₀) (9)

The ES 100 generates a line segment from each of the position of the ES that retains copy data (positioned indicated by a white triangle in FIG. 35) to the data acquisition completion estimated position 63. The ES 100 selects an ES in which the corresponding line segment does not intersect with any of the first straight line 64 and the second straight line 65, as a registration target into the copy-data retention ES list.

The third embodiment is different from the second embodiment from a point of the response generation process among the processes of the ES 100.

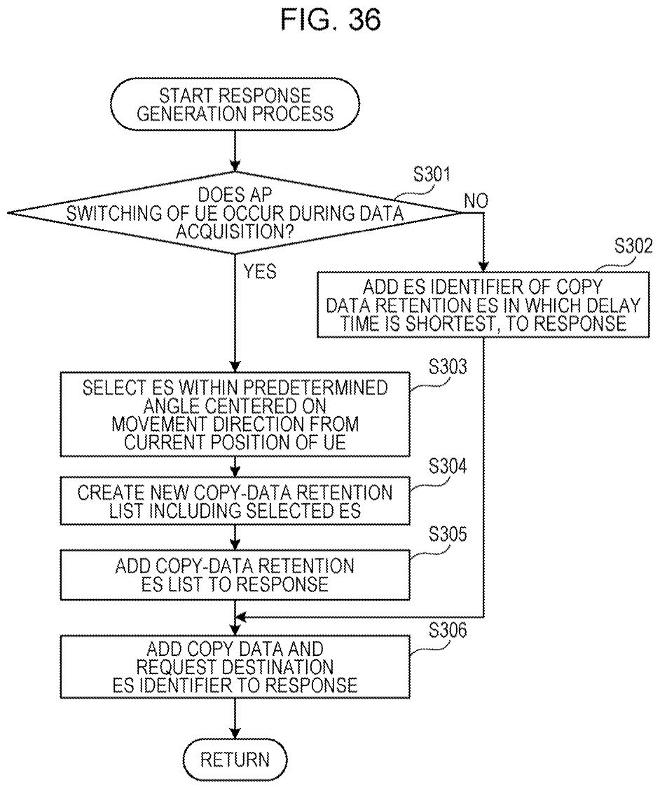

FIG. 36 is a flowchart illustrating an example of a procedure of the response generation process in the third embodiment. The processing illustrated in FIG. 36 will be described below with step numbers.

[Step S301] The request processing unit 140 requests determination of whether or not the data acquisition request succeeds, from the request status prediction unit 150, and determines whether or not the AP is switched in the middle of the UE 200 acquiring data. In a case where it is determined that the AP is switched, the request processing unit 140 causes the process to proceed to Step S303. In a case where it is determined that the AP is not switched, the request processing unit 140 causes the process to proceed to Step S302.

[Step S302] The request processing unit 140 includes an ES identifier of an ES in which a delay time between the ES and the ES 100 is the shortest, and copy data is retained, in the copy-data retention ES list acquired from the center server 300, in a response as a copy-data retention ES list. Then, the request processing unit 140 causes the process to proceed to Step S306.

[Step S303] The request processing unit 140 sets the current position of the UE 200 as a start point and selects an ES in a direction within a predetermined angle with the movement direction of the UE 200 from the start point as the center.

[Step S304] The request processing unit 140 creates a copy-data retention ES list including an ES identifier of the ES selected in Step S303 among ESs registered in the copy-data retention ES list acquired from the UE 200 or the center server 300.

[Step S305] The request processing unit 140 adds the copy-data retention ES list created in Step S304 to a response.

[Step S306] The request processing unit 140 adds the copy data and an ES identifier of a request destination ES (ES 100) to the response.

In this manner, the ES to be registered in the copy-data retention ES list is limited in accordance with the movement direction of the UE 200. As a result, in a determination of whether or not data acquisition is completed, even in a case where it is determined that data acquisition is not completed, it is possible to reduce the size of the copy-data retention ES list.

### Fourth Embodiment

Next, a fourth embodiment will be described. In the fourth embodiment, even in a case where the UE moves between APs during data acquisition, the number of ES identifiers in the copy-data retention ES list retained by the UE is reduced depending on the data acquisition completion estimated position. The fourth embodiment may be combined with the third embodiment.

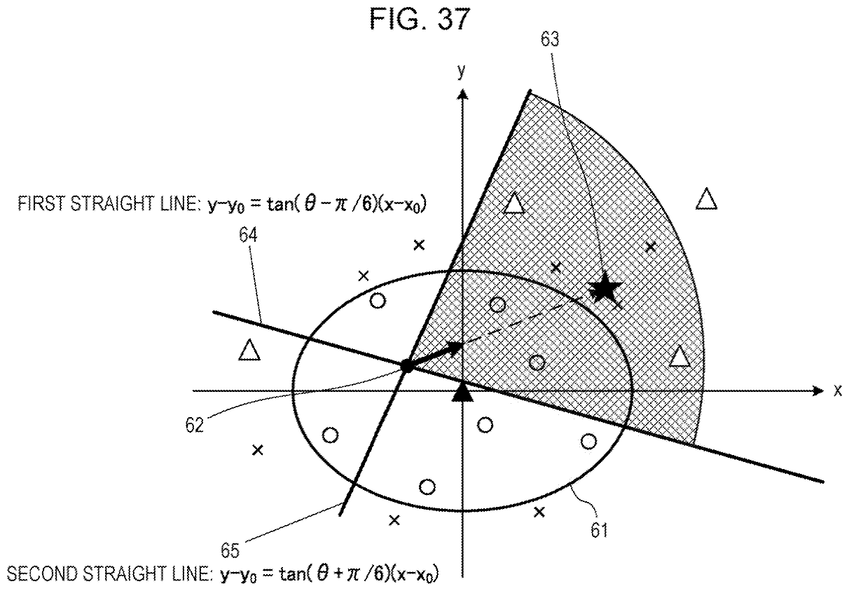

FIG. 37 is a diagram illustrating a determination example of the size of the copy-data retention ES list retained by the UE, depending on the movement distance of the UE. For example, the ES 100 that receives a data acquisition request from the UE 200 determines whether or not the data acquisition request succeeds, by using the determination model 111. Information such as “the movement speed”, “the movement direction”, and “the position” of which the notification is received from the UE 200, and “the data size” obtained as a result of the inquiry from the center server 300, and the position of the ES 100 that receives the data acquisition request are input to the determination model 111. The ES 100 predicts whether or not the data acquisition request succeeds, based on the information. The determination process of whether or not the data acquisition request succeeds is similar to that in the second embodiment. In the process of determining whether or not the data acquisition request succeeds, a data acquisition completion estimated position 63 is calculated based on information such as a UE current position 62. In the fourth embodiment, in a case where the data acquisition completion estimated position 63 is on the outside of a boundary line 61 of the communication available range of the AP 31 coupled to the ES 100, the ES 100 limits ESs to be registered in the copy-data retention ES list in accordance with the UE current position 62 and the movement direction. In a case where the data acquisition completion estimated position 63 is on the outside of the boundary line 61 of the communication available range of the AP 31 coupled to the ES 100, the ES 100 limits ESs to be registered in the copy-data retention ES list, to be an ES in a predetermined distance from the UE current position 62.

For example, in a case where it is determined that data acquisition is completed, the ES 100 includes only an ES identifier of an ES as the acquisition source of copy data which is being currently acquired, in the copy-data retention ES list for the UE 200. In a case where it is determined that data acquisition is not completed, the ES 100 reduces the number of ES identifiers to be included in the copy-data retention ES list in accordance with the movement direction of the UE 200 and the movement distance until data acquisition is completed.

Specifically, the ES 100 determines whether or not each of the ESs that retain copy data is selected as a registration target into the copy-data retention ES list, by the following method.

For example, the current position of the UE 200 is set to (x₀, y₀), and the data acquisition completion estimated position is set to (x′, y′). A movement estimated distance of the UE 200 is set to dᵤₑ, and an average wireless coverage of the AP 31 is set to d_{w}. An ES which is in a range of the radius (dᵤₑ+d_{w}) from the current position of the UE 200 and is in a range of 30° (π/6) to the right and left of the movement direction is set to a registration target into the copy-data retention ES list.

Similar to the third embodiment, the ES 100 obtains the first straight line 64 and the second straight line 65. The ES 100 determines whether or not the position (x, y) of the ES satisfies the following expression, and thus determines whether or not the ES is in the range of the radius (dᵤₑ+d_{w}) from the current position of the UE 200.

(dᵤₑ−d_{w})²≥{(x−x₀)²+(y−y₀)²} (10)

The ES 100 selects an ES which is in the range of the radius (dᵤᵥ+d_{w}) from the UE current position 62 and in which a line segment joining the ES and the data acquisition completion estimated position 63 does not intersect with any of the first straight line 64 and the second straight line 65, as the registration target into the copy-data retention ES list.

The fourth embodiment is different from the second embodiment from a point of the response generation process among the processes of the ES 100.

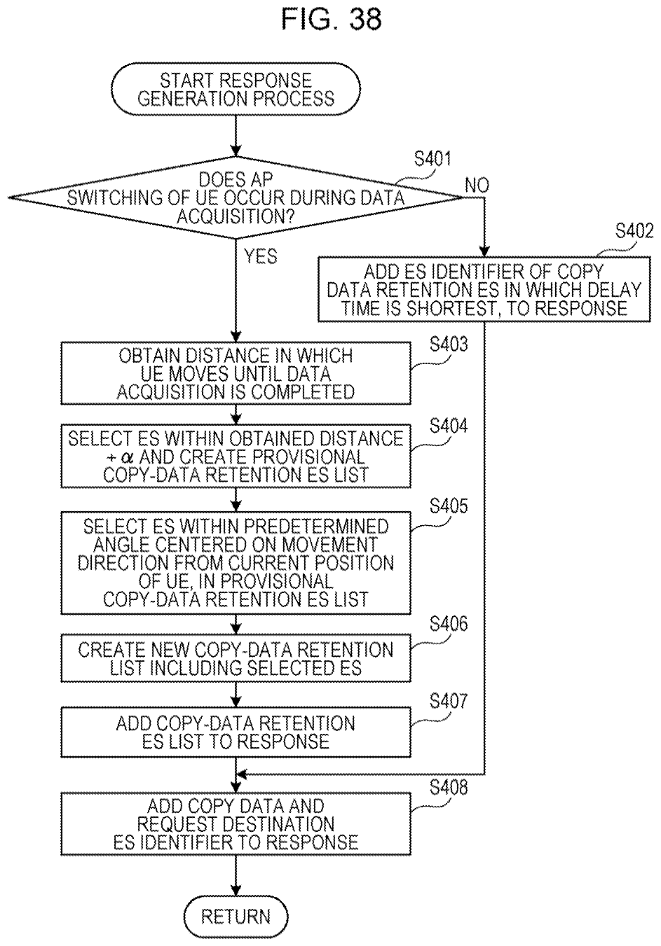

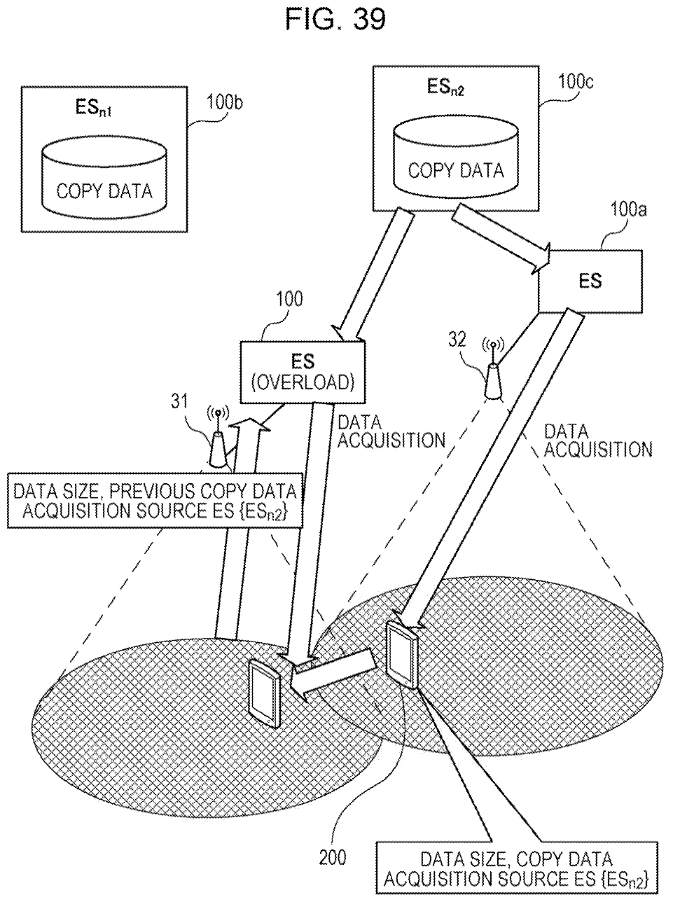

FIG. 38 is a flowchart illustrating an example of a procedure of the response generation process in the fourth embodiment. The processing illustrated in FIG. 38 will be described below with step numbers.

[Step S401] The request processing unit 140 requests determination of whether or not the data acquisition request succeeds, from the request status prediction unit 150, and determines whether or not the AP is switched in the middle of the UE 200 acquiring data. In a case where it is determined that the AP is switched, the request processing unit 140 causes the process to proceed to Step S403. In a case where it is determined that the AP is not switched, the request processing unit 140 causes the process to proceed to Step S402.

[Step S402] The request processing unit 140 includes an ES identifier of an ES in which a delay time between the ES and the ES 100 is the shortest, and copy data is retained, in the copy-data retention ES list acquired from the center server 300, in a response as a copy-data retention ES list. Then, the request processing unit 140 causes the process to proceed to Step S408.

[Step S403] The request processing unit 140 obtains a distance in which the UE 200 moves until data acquisition is completed.

[Step S404] The request processing unit 140 selects an ES within the obtained distance+α (α is, for example, the average wireless coverage d_{w} of the AP 31) among ESs indicated in the copy-data retention ES list acquired from the UE 200 or the center server 300. The request processing unit 140 creates a provisional copy-data retention ES list including an ES identifier of the selected ES.

[Step S405] The request processing unit 140 sets the current position of the UE 200 as a start point and selects an ES in a direction within a predetermined angle with the movement direction of the UE 200 from the start point as the center.

[Step S406] The request processing unit 140 creates a copy-data retention ES list including an ES identifier of the ES selected in Step S405 among ESs registered in the provisional copy-data retention ES list.

[Step S407] The request processing unit 140 adds the copy-data retention ES list created in Step S406 to a response.

[Step S408] The request processing unit 140 adds the copy data and an ES identifier of a request destination ES (ES 100) to the response.

In this manner, the ES to be registered in the copy-data retention ES list is limited in accordance with the movement distance of the UE 200 until data acquisition is completed, and the movement direction of the UE 200. As a result, in a determination of whether or not data acquisition is completed, even in a case where it is determined that data acquisition is not completed, it is possible to reduce the size of the copy-data retention ES list.

### Fifth Embodiment

Next, a fifth embodiment will be described. In the fifth embodiment, in a case where a processing load over the ES 100 that receives a data acquisition request is large, the ES 100 acquires copy data without performing the inquiry from the center server 300 and the determination process of the ES having the shortest data acquisition time.

FIG. 39 is a diagram illustrating an example of the copy data acquisition process in a case where a processing load of the ES becomes too much. For example, it is assumed that the UE 200 acquires copy data from the ES 100c having the shortest acquisition time of copy data by the ES 100b, through the ES 100b. The ES 100a includes the data size and the ES identifier “ESₙ₂” of the ES 100c as the copy data acquisition source, in a response which includes the copy data and is transmitted to the UE 200.

It is assumed that, when the UE 200 is located in the communication available range of the AP 31 coupled to the ES 100, an acquisition instruction of data identical to the copy data acquired through the ES 100b is input from the user. The UE 200 includes the data size and the ES identifier “ESₙ₂” of the previous copy data acquisition source ES for the ES 100.

The ES 100 determines whether or not the processing load of the ES 100 is overloaded and whether or not the data size of copy data designated by the data acquisition request is equal to or smaller than a predetermined value. If the ES 100 is overloaded, and the data size is equal to or smaller than the predetermined value, the ES 100 acquires copy data from the previous copy data acquisition source ES without transmitting an inquiry of the copy-data retention ES list to the center server 300.

The fifth embodiment is different from the second embodiment in that the data size and the ES identifier of the ES as the copy data acquisition source are included in the response as illustrated in FIG. 39 among the processes of the ES 100. The fifth embodiment is different from the second embodiment in that the data size and the ES identifier of the ES as the copy data acquisition source are included in the data acquisition request as illustrated in FIG. 39 among the processes of the UE 200. The fifth embodiment is different from the second embodiment from a point of the copy data acquisition process.

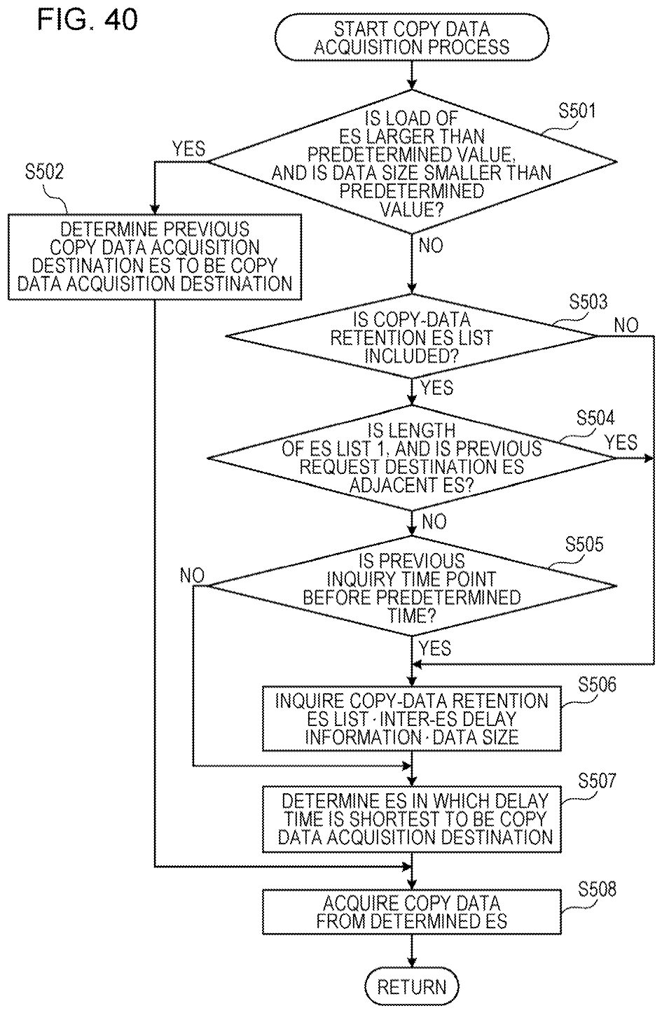

FIG. 40 is a flowchart illustrating an example of a procedure of the copy data acquisition process in the fifth embodiment. Among the process illustrated in FIG. 40, Steps S503 to S508 are similar to Steps S111 to S116 of the copy data acquisition process in the second embodiment illustrated in FIG. 26. The processes of Steps S501 to S502 different from the second embodiment will be described below with step numbers.

[Step S501] The request processing unit 140 determines whether or not conditions that the load of the ES 100 exceeds a predetermined value, and the data size of data designated by the data acquisition request is smaller than a predetermined value are satisfied. The load of the ES 100 may be measured by, for example, a CPU usage rate, a memory usage rate, and the like. In a case where the conditions are satisfied, the request processing unit 140 causes the process to proceed to Step S502. In a case where the conditions are not satisfied, the request processing unit 140 causes the process to proceed to Step S503.

[Step S502] The request processing unit 140 determines an ES as a copy data acquisition destination when the UE 200 has previously acquired copy data to be the current copy data acquisition destination. Then, the request processing unit 140 causes the process to proceed to Step S508.

Thus, it is possible to suppress an increase of a load of the overloaded ES 100. Since the size of data to be acquired is small, the extended communication time is very short even though the copy data is acquired from the ES other than the ES having the shortest delay time.

### Other Embodiments

In the second embodiment, the center server 300 generates the determination model. However, the ES 100 that receives the data acquisition request may generate the determination model based on the coupling tendency log 113 of the ES 100.

In the second embodiment, the ES 100 or 100a that receives the data acquisition request are distinguished from the ES 100b or 100c that retains copy data. However, one ES perform both reception of the data acquisition request and retention of the copy data. In this case, each ES has the function of the ES 100 illustrated in FIG. 11 and the function of the ES 100b together.

Although the embodiments have been described, the configurations of the units described in the embodiments are able to be replaced with other units having the same functions. Any other constituents or processes may be added. Any two or more configurations (features) of the aforementioned embodiments may be combined.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory, computer-readable recording medium having stored therein a program for causing a computer to execute a process comprising:
receiving, at a distributed data transfer control device coupled to a base station, a data acquisition request of data retained by a plurality of servers from a mobile terminal wirelessly coupled to the base station;
determining whether a first list is included in the data acquisition request, the first list indicating at least some of the plurality of servers as a data retention server that retains the data;
when the first list is not included in the data acquisition request, acquiring a second list indicating the plurality of servers as the data retention server, from a management server that manages a distributed storage destination of the data;
based on a communication speed between the distributed data transfer control device and each of the data retention servers indicated in the first list or the second list, identifying one of the data retention servers as an acquisition destination server to acquire the data from the acquisition destination server;
determining whether the mobile terminal is capable of completing acquisition of the data in a period in which the mobile terminal stays within a communication available range of the base station, based on a current position, a movement direction, and a movement speed of the mobile terminal and a data size of the data;
when it is determined that completion of acquisition of the data in the period is possible, creating a third list indicating the acquisition destination server as the data retention server;
when it is determined that the completion of the acquisition of the data in the period is not possible, creating a fourth list that indicates two or more of the plurality of servers indicated in the second list as the data retention server; and
transmitting the data, and the third list or the fourth list to the mobile terminal.

2. The non-transitory, computer-readable recording medium of claim 1, wherein:
when the data acquisition request includes the first list, the data acquisition request further includes previous request destination information indicating a server that has provided the first list to the mobile terminal;
the process further comprises:
determining whether the first list is valid based on a number of the data retention servers indicated in the first list and the previous request destination information, and
acquiring the second list from the management server when the first list is not valid; and
when the first list is not valid, the acquisition destination server is selected based on the communication speed with each of the data retention servers indicated in the second list.

3. The non-transitory, computer-readable recording medium of claim 2, wherein, it is determined that the first list is valid in a first case where the number of the data retention servers indicated in the first list is one and the device that has provided the first list to the mobile terminal is the computer, or in a second case where the number of the retention servers indicated in the first list is two or more.

4. The non-transitory, computer-readable recording medium of claim 1, wherein, in the determining of whether the completion of the acquisition of the data is possible, a data acquisition completion estimated position indicating a position of the mobile terminal when the acquisition of the data is completed is calculated based on the current position, the movement direction, the movement speed of the mobile terminal, and the data size of the data, and it is determined whether the completion of the acquisition of the data is possible, based on whether the data acquisition completion estimated position is within a communication available range of the base station coupled to the computer.

5. The non-transitory, computer-readable recording medium of claim 1, wherein, in the creating of the fourth list, the fourth list that indicates, as the data retention server, a server present in a direction within a predetermined angle with respect to the movement direction of the mobile terminal from the current position of the mobile terminal to is created.

6. The non-transitory, computer-readable recording medium of claim 1, wherein, in the creating of the fourth list, the fourth list that indicates, as the data retention server, a server present in a predetermined distance from the current position of the mobile terminal is created.

7. The non-transitory, computer readable recording medium of claim wherein:
a previous data acquisition source server that is an acquisition destination from which the mobile terminal previously acquired the data is indicated in the data acquisition request; and
the process further comprises:
determining whether a load of the computer when receiving the data acquisition request exceeds a predetermined value, and
when the load exceeds the predetermined value, suspending an acquisition process of the second list and acquiring the data from the previous data acquisition source server.

8. A method performed by a computer, the method comprising:
receiving, at a distributed data transfer control device coupled to a base station, a data acquisition request of data retained by a plurality of servers from a mobile terminal wirelessly coupled to the base station
determining whether a first list is included in the data acquisition request, the first list indicating at least some of the plurality of servers as a data retention server that retains the data;
when the first list is not included in the data acquisition request, acquiring a second list indicating the plurality of servers as the data retention server, from a management server that manages a distributed storage destination of the data;
based on a communication speed between the distributed data transfer control device and each of the data retention servers indicated in the first list or the second list, identifying one of the data retention servers as an acquisition destination server to acquire the data from the acquisition destination server;
determining whether the mobile terminal is capable of completing acquisition of the data in a period in which the mobile terminal stays within a communication available range of the base station, based on a current position, a movement direction, and a movement speed of the mobile terminal and a data size of the data;
when it is determined that completion of acquisition of the data in the period is possible, creating a third list indicating the acquisition destination server as the data retention server;
when it is determined that the completion of the acquisition of the data in the period is not possible, creating a fourth list that indicates two or more of the plurality of servers indicated in the second list as the data retention server; and
transmitting the data, and the third list or the fourth list to the mobile terminal.

9. An apparatus comprising:
a memory configured to store a communication speed with each of a plurality of servers; and
a processor coupled to the memory and configured to:
receive a data acquisition request of data retained by the plurality of servers from a mobile terminal wirelessly coupled to a base station,
determine whether a first list is included in the data acquisition request, the first list indicating at least some of the plurality of servers as a data retention server that retains the data,
when the first list is not included in the data acquisition request, acquire a second list indicating the plurality of servers as the data retention server, from a management server that manages a distributed storage destination of the data,
based on a communication speed between the apparatus and each of the data retention servers indicated in the first list or the second list, identify one of the data retention servers as an acquisition destination server to acquire the data from the acquisition destination server,
determine whether the mobile terminal is capable of completing acquisition of the data in a period in which the mobile terminal stays within a communication available range of the base station, based on a current position, a movement direction, and a movement speed of the mobile terminal and a data size of the data,
when it is determined that completion of acquisition of the data in the period is possible, create a third list indicating the acquisition destination server as the data retention server,
when it is determined that the completion of the acquisition of the data in the period is not possible, create a fourth list that indicates two or more of the plurality of servers indicated in the second list as the data retention server, and
transmit the data, and the third list or the fourth list to the mobile terminal.
